(19) United States
(12) Patent Application Publication
(10) Pub. No.: US 2023/0323176 A1
(43) Pub. Date: Oct. 12, 2023

(54) COMPOSITION COMPRISING A SLURRY OF CAPSULES AND METHODS THEREOF

(71) Applicants: Agency for Science, Technology and Research, Singapore (SG); NIPO International Pte. Ltd., Singapore (SG)

(72) Inventors: Praveen Thoniyot, Singapore (SG); Sam Siming Dong, Singapore (SG); Yi Jie Eng, Singapore (SG); Steve Tan, Singapore (SG); Amanda Khoo, Singapore (SG)

(21) Appl. No.: 17/718,802

(22) Filed: Apr. 12, 2022

(51) Int. Cl. C09K 5/02; C04B 22/06; C04B 24/04; B01J 13/04; C04B 24/38

(52) U.S. Cl. CPC C09K 5/02; C04B 22/06; C04B 24/04; B01J 13/04; C04B 24/383; C04B 2103/0071

(57) ABSTRACT

There is provided a composition comprising a slurry of capsules, the capsules having shells comprising silica and said shells encapsulating phase change materials (PCM); and a cementitious binder. There is also provided a method for preparing said composition.

### TECHNICAL FIELD

The present disclosure relates broadly to a composition comprising a slurry of capsules and methods thereof.

### BACKGROUND

With an emphasis on improving urban sustainability, focus has been placed on incorporating phase change material into building constructions with the view of absorbing the heat and regulating temperatures of buildings for energy saving reasons.

Phase change materials (PCM) are materials that can absorb or release heat at phase transition temperature to provide heating/cooling. PCM can be introduced into construction materials such as concrete. However, such introduction may negatively affect the strength of the building and hence incorporating them in coatings has been considered. One manner of incorporating phase change materials into coating would be to incorporate them through the painting work in buildings. Introducing PCM into coatings also enables the renewal of existing buildings into more energy efficient buildings with desirable ambient temperatures in these buildings.

Prior to painting, a skim coat is typically first applied to the building walls. The skim coat is a thin coat to create flat and uniform surfaces on walls for painting work. However, a large volume of PCM is usually needed to effectively absorb the heat and regulate the temperature and thus the thinness of the skim coat makes it challenging to incorporate a sufficient amount of PCM material therein effectively and stably. Furthermore, even though the benefit of using PCM has been demonstrated through several small scale studies, the use of PCM in skim coatings has not been commercialized yet due to high processing cost of involving PCM, leading to a situation where any potential energy savings are not sufficient to recover the investment.

In view of the above, there is thus a need to provide a composition comprising a slurry of capsules and methods thereof that address or at least ameliorate one or more of the above problems.

### SUMMARY

In one aspect, there is provided a composition comprising:
a slurry of capsules, the capsules having shells comprising silica and said shells encapsulating phase change materials (PCM); and
optionally a cementitious binder.

In one embodiment, the slurry has a pH of no less than 5.

In one embodiment, the slurry comprises multivalent metal ions.

In one embodiment, the multivalent metal ions comprise calcium ions.

In one embodiment, the composition further comprises diatomite.

In one embodiment, the composition further comprises one or more of latex, an organic/synthetic polymer, filler, or graphite.

In one embodiment, the composition comprises diatomite and filler at a ratio of from 1:3 to 1:1.

In one embodiment, the latex when present is present at an amount of from 0.5 wt % to 10 wt % based on the dry weight of the composition, the filler when present is present at an amount of from 5 wt % to 55 wt % based on the dry weight of the composition, and the organic polymer when present is present at an amount of from 0.05 wt % to 0.5 wt %.

In one embodiment, the capsules are present at an amount of from 2.5 wt % to 50 wt % based on the dry weight of the composition.

In one embodiment, the cementitious binder is present at an amount of from 20 wt % to 60 wt % based on the dry weight of the composition.

In one embodiment, the diatomite is present at an amount of from 5 wt % to 20 wt % based on the dry weight of the composition.

In one embodiment, the total water content of the composition is from 5 wt % to 50 wt %.

In one embodiment, the composition disclosed herein comprises:
from 10 wt % to 30 wt % of capsules based on the dry weight of the composition;
from 30 wt % to 50 wt % of cement based on the dry weight of the composition;
from 10 wt % to 50 wt % of sand and/or calcium carbonate based on the dry weight of the composition;
from 5 wt % to 20 wt % of diatomite based on the dry weight of the composition;
from 1 wt % to 5 wt % of latex based on the dry weight of the composition;
from 0.05 wt % to 0.5 wt % of cellulose based on the dry weight of the composition;
from 5 wt % to 50 wt % total water content of the composition; and
optionally from 0.1 wt % to 2 wt % of performance enhancing additives based on the dry weight of the composition.

In one aspect, there is provided a method of preparing the composition disclosed herein, the method comprising:
providing a slurry of capsules, the capsules having shells comprising silica and said shells encapsulating phase change materials (PCM); and
optionally mixing the slurry of capsules with a cementitious binder.

In one embodiment, providing the slurry of capsules comprises:
adding a silica precursor to emulsified droplets of PCM in the presence of salt and alcohol to enhance silica growth around the emulsified droplets, thereby forming the slurry of capsules having shells comprising silica and encapsulating PCM.

In one embodiment, the salt comprises a multivalent metal salt, the silica precursor comprises an alkoxy silane and the alcohol is selected from the group consisting of: methanol, ethanol, propanol, isopropanol and combinations thereof.

In one embodiment, the method further comprises adding a pH adjusting agent to the slurry of capsules to obtain a pH of no less than 5.

In one embodiment, the pH adjusting agent comprises an alkaline pH adjusting agent.

In one embodiment, the method further comprises mixing one or more of a filler, diatomite, latex and organic polymer with the slurry of capsules.

In one embodiment, the method comprises:
adding cement, sand and/or calcium carbonate, diatomite, latex and cellulose to the slurry of capsules; and
optionally adding additional water to the mixture of cement, sand and/or calcium carbonate, diatomite, latex, cellulose and capsules,
wherein the final composition comprises from 10 wt % to 30 wt % of capsules based on the dry weight of the composition, from 30 wt % to 50 wt % of cement based on the dry weight of the composition, from 10 wt % to 50 wt % of sand and/or calcium carbonate based on the dry weight of the composition, from 5 wt % to 20 wt % of diatomite based on the dry weight of the composition, from 1 wt % to 5 wt % of latex based on the dry weight of the composition, from 0.05 wt % to 0.5 wt % of cellulose based on the dry weight of the composition, and from 5 wt % to 50 wt % total water content of the composition.

### DEFINITIONS

The term “micro” as used herein is to be interpreted broadly to include dimensions from about 1 micron to about 1000 microns and from about 1 micron to about 100 microns.

The term “nano” as used herein is to be interpreted broadly to include dimensions less than about 1000 nm and from about 1 nm to about 100 nm.

The term “particle” as used herein broadly refers to a discrete entity or a discrete body. The particle described herein can include an organic, an inorganic or a biological particle. The particle used described herein may also be a macro-particle that is formed by an aggregate of a plurality of sub-particles or a fragment of a small object. The particle of the present disclosure may be spherical, substantially spherical, or non-spherical, such as irregularly shaped particles or ellipsoidally shaped particles. The term “size” when used to refer to the particle broadly refers to the largest dimension of the particle. For example, when the particle is substantially spherical, the term “size” can refer to the diameter of the particle; or when the particle is substantially non-spherical, the term “size” can refer to the largest length of the particle. The term “size” as used herein also broadly refers to the “mean hydrodynamic diameter” that may be deduced from a laser scattering experiment of a dispersion of particles or the average of the longest dimensions determined from a transmission electron microscopy experiment or scanning electron microscopy experiment.

The terms “coupled” or “connected” as used in this description are intended to cover both directly connected or connected through one or more intermediate means, unless otherwise stated.

The term “associated with”, used herein when referring to two elements refers to a broad relationship between the two elements. The relationship includes, but is not limited to a physical, a chemical or a biological relationship. For example, when element A is associated with element B, elements A and B may be directly or indirectly attached to each other, or element A may contain element B or vice versa.

The term “adjacent” used herein when referring to two elements refers to one element being in close proximity to another element and may be but is not limited to the elements contacting each other or may further include the elements being separated by one or more further elements disposed therebetween.

The term “and/or”, e.g., “X and/or Y” is understood to mean either “X and Y” or “X or Y” and should be taken to provide explicit support for both meanings or for either meaning.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For example, when “comprising” is used, reference to a “one” feature is also intended to be a reference to “at least one” of that feature. Terms such as “consisting”, “consist”, and the like, may in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. It is to be appreciated that the individual numerical values within the range also include integers, fractions and decimals. Furthermore, whenever a range has been described, it is also intended that the range covers and teaches values of up to 2 additional decimal places or significant figures (where appropriate) from the shown numerical end points. For example, a description of a range of 1% to 5% is intended to have specifically disclosed the ranges 1.00% to 5.00% and also 1.0% to 5.0% and all their intermediate values (such as 1.01%, 1.02% . . . 4.98%, 4.99%, 5.00% and 1.1%, 1.2% . . . 4.8%, 4.9%, 5.0% etc.,) spanning the ranges. The intention of the above specific disclosure is applicable to any depth/breadth of a range.

Additionally, when describing some embodiments, the disclosure may have disclosed a method and/or process as a particular sequence of steps. However, unless otherwise required, it will be appreciated that the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Furthermore, it will be appreciated that while the present disclosure provides embodiments having one or more of the features/characteristics discussed herein, one or more of these features/characteristics may also be disclaimed in other alternative embodiments and the present disclosure provides support for such disclaimers and these associated alternative embodiments.

### DESCRIPTION OF EMBODIMENTS

Exemplary, non-limiting embodiments of a composition comprising a slurry of capsules and related methods thereof are disclosed hereinafter.

### Composition

In various embodiments, there is provided composition comprising a slurry of capsules, the capsules having shells comprising silica and said shells encapsulating phase change materials (PCM); and optionally a cementitious binder. The composition may be suitable for cementitious applications and/or coating applications such as a skim-coat, as a topcoat and/or as a paint composition. In some embodiments, there is provided a composition for skim-coating. Advantageously, embodiments of the composition are useful for absorbing heat and regulating temperature due to presence of PCM and thus are suitable for use to coat buildings. Embodiments of the composition also advantageously allow for high loading of PCM in the compositions as compared to conventional coating formulations as the PCM is being encapsulated in a robust manner. This ability to allow high loading of the PCM in the compositions make embodiments of the compositions suitable for coating buildings to achieve desirable ambient temperatures in these buildings resulting in energy saving for urban sustainability. Furthermore, the presence of silica in the shell of the capsule advantageously allows for high compatibility of the compositions with cementitious building material as compared with polymeric shells. Additionally, methods of using a polymeric shell material to encapsulate an organic PCM were also found to increase flammability (e.g. due to the combination of organic PCM and polymeric shell material used, both being combustible) and thus is not as desirable as compared to the use of a robust silica containing shell to encapsulate PCM, the latter being specifically suitable for skim coating to be used on buildings. Advantageously, embodiments of the composition disclose herein allow for a skim coat having from about 3 mm to about 6 mm thickness to be formed, which is a suitable carrier for PCM to be used in building applications such as for renewing existing buildings to improve energy efficiency.

In various embodiments, the shells of the capsules are silica shells. In some embodiments, the silica capsule comprises a silica shell that is not coated with a second non-silica layer/shell (e.g. a polymer layer/shell) or with a silica-polymer hybrid shell. In some embodiments, the silica shell does not comprise more than one distinct layer i.e. the silica shell may contain only one single silica layer. In some embodiments, the silica shell is substantially homogenous. In some embodiments, the silica shell consists of silicon oxide.

Thus, in various embodiments the capsules are silica shell-PCM core particles or core-shell PCM-silica capsules. In various embodiments, the capsules are produced in a slurry format and added to the formulation. The slurry may be an aqueous slurry and thus contain water as the aqueous liquid medium. Although in various embodiments, the cementitious binder may be interspersed with the slurry of capsules in the composition (e.g. after the cement is added to the slurry or vice versa), it will be appreciated that this is different from adding dry capsules (e.g. powder form) to cement to form a slurry thereafter (e.g. adding the dry capsules to a wet cement slurry or adding dry capsules to dry cement before adding water to form an overall slurry). The inventors have surprising found that the formulation of capsule in the powder format was not effective in preparing a skim coat that is substantially defect free.

In various embodiments, the capsules have a size/diameter/particle size/particle size distribution/average particle size in the range of from about 100 nm to about 100 μm, from about 500 nm to about 100 μm, from about 1 μm to about 100 μm, from about 100 nm to about 80 μm, from about 1 μm to about 80 μm, from about 1 μm to about 60 μm, from about 1 μm to about 50 μm, from about 1 μm to about 40 μm, from about 1 μm to about 30 μm, from about 1 μm to about 20 μm, from about 1 μm to about 10 μm, from about 1 μm to about 8 μm, from about 8 μm to about 50 μm, from about 8 μm to about 40 μm, from about 8 μm to about 30 μm, from about 8 μm to about 20 μm, from about 8 μm to about 10 μm, no less than about 8 μm, no less than about 9 μm, or no less than about 10 μm, no less than about 20 μm, no less than about 30 μm, no less than about 40 μm or no less than about 50 μm. In some embodiments, the capsule is micron-sized and thus are microcapsules. In some embodiments, the silica capsule is no more than about 100 μm.

In various embodiments, the capsules have a size/diameter/particle size/particle size distribution/average particle size in the range of from about 0.15 μm to about 1 μm (or from about 150 nm to about 1,000 nm). In various embodiments therefore, the capsules comprise sub-micron capsules. Capsules having submicron size/structures may be used for improving properties such as achieving better adhesion and/or higher compressive strength in many applications.

In various embodiments, the capsules are present at an amount of from about 2 wt % to about 50 wt %, from about 2.5 wt % to about 50 wt %, from about 3 wt % to about 50 wt %, from about 4 wt % to about 50 wt %, from about 5 wt % to about 49 wt %, from about 6 wt % to about 48 wt %, from about 7 wt % to about 47 wt %, from about 8 wt % to about 46 wt %, from about 9 wt % to about 45 wt %, from about 10 wt % to about 40 wt %, from about 25 wt % to about 35 wt %, from about 10 wt % to about 30 wt %, or from about 20 wt % to about 30 wt % based on the dry weight of the composition. In some embodiments, when higher loading of capsules is used (e.g. more than 30%) for better temperature performance, additional use of bonding agents such as epoxy with the composition might alleviate any reduction of the mechanical strength and bonding of the coatings caused by high capsule loading. This could be overcome by usage of bonding agents such as epoxy. Alternatively, using higher performance PCM in the capsule may eliminate the need to use higher dosage of PCM capsule for better temperature control. In various embodiments, limiting the loading of the capsules to no more than about 50 wt % may prevent problems that may result from high loading (more than 50 wt %) such as lower/lesser strength of coating, presence of coating defects and/or higher cost associated with high loading.

In various embodiments, the phase change materials (PCM) comprise organic PCM. In some embodiments, the PCM are bio-based and may be derived from plants and animals (e.g. feedstock). The phase change material may have one or more of the following chemical groups: an acid anhydride group, an alkenyl group, an alkynyl group, an alkyl group, an aldehyde group, an amide group, an amino group and their salts, a N-substituted amino group, an aziridine, an aryl group, a carbonyl group, a carboxy group and their salts (e.g., fatty acid), an epoxy group, an ester group (e.g., fatty acid ester or polyester), an ether group, a glycidyl group, a halo group, a hydride group, a hydroxy group, an isocyanate group, a thiol group, a disulfide group, a silyl or silane group, an urea group, an urethane group, or combinations thereof. In various embodiments, the PCM comprises but are not limited to paraffinic hydrocarbons, salt hydrates, glycols, naphthalene, paraffin mixtures (e.g., Pluss OM-28P), fatty acid mixtures (e.g., Pluss OM-29), fatty acid ester mixtures (e.g., Crodatherm 29 (CM29) and SL28), commercially available polyesters and polymeric materials having high latent heat or combinations thereof. Advantageously, PCM store thermal energy via the latent heat of phase transitions and thus PCMs may be used to provide district cooling (sub ambient transition temperatures), to buffer thermal swings in buildings (near ambient transition temperatures).

In various embodiments, the slurry (e.g., slurry containing capsules or PCM microcapsule containing slurry) is adjusted to have a pH of no less than about 5, no less than a pH of about 5.5, or no less than a pH of about 6. The slurry may have a pH range of from about 5 to about 8, from about 5.1 to about 7.9, from about 5.2 to about 7.8, from about 5.3 to about 7.7, from about 5.4 to about 7.6, from about 5.5 to about 7.5, from about 5.6 to about 7.4, from about 5.7 to about 7.3, from about 5.8 to about 7.2, from about 5.9 to about 7.1, or from about 6 to 7. In some embodiments, the slurry containing capsules (e.g., PCM capsules) has a pH of from about 6.0 to 8.0, or from about 7.0 to 8.0. The inventors have found out that if the slurry with low pH is used, the skim coats obtained are weak and contain crack. Advantageously, when the pH of the slurry is increased to a value in the above ranges, the strength of the skim coat was found to be increased with little or no cracks. In various embodiments, the pH of the slurry is adjusted (e.g., to from about 6.0 to 8.0) before mixing with cementitious binder (e.g., cement). Without being bound by theory, it is believed that cementitious binder/materials perform better at higher pH (e.g., pH≥6.5), with the performance deteriorating if the pH is below about 6.5.

In various embodiments, the composition has an overall pH of no less than about 5.0, no less than a pH of about 5.5, no less than a pH of about 6.0, no less than a pH of about 6.5, or no less than a pH of about 7.0. The slurry may have a pH range of from about 7.0 to about 14.0, from about 7.1 to about 13.9, from about 7.2 to about 13.8, from about 7.3 to about 13.7, from about 7.4 to about 13.6, from about 7.5 to about 13.5, from about 7.6 to about 13.4, from about 7.7 to about 13.3, from about 7.8 to about 13.2, from about 7.9 to about 13.1, from about 8.0 to about 13.0, from about 8.1 to about 12.9, from about 8.2 to about 12.8, from about 8.3 to about 12.7, from about 8.4 to about 12.6, from about 8.5 to about 12.5, from about 8.6 to about 12.4, from about 8.7 to about 12.3, from about 8.8 to about 12.2, from about 8.9 to about 12.1, from about 9.0 to about 12.0, from about 9.1 to about 11.9, from about 9.2 to about 11.8, from about 9.3 to about 11.7, from about 9.4 to about 11.6, from about 9.5 to about 11.5, from about 9.6 to about 11.4, from about 9.7 to about 11.3, from about 9.8 to about 11.2, from about 9.9 to about 11.1, from about 10.0 to about 11.0, from about 10.1 to about 10.9, from about 10.2 to about 10.8, from about 10.3 to about 10.7, from about 10.4 to about 10.6, or about 10.5. In various embodiments, the pH of the slurry is proportional to the pH of the composition, that is, if the slurry has a lower pH then the pH of the composition will also be lowered.

In various embodiments, the PCM slurry further comprises multivalent metal ions e.g. divalent or trivalent metal ions. Advantageously, the inventors have found that by using multivalent salts e.g. divalent or trivalent salts (as opposed to monovalent salts) when preparing the capsules, the slurry of capsules obtained would have much better compatibility with the other components of the composition such as the cement, leading to an overall increase in strength of the composition and skim coatings obtained using the composition. In various embodiments, the multivalent metal ions comprise cations of or derived from alkaline-earth metals (i.e. beryllium (Be), magnesium (Mg), calcium (Ca), strontium (Sr), barium (Ba), and radium (Ra)), transition metals (e.g., scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), lanthanum (La), hafnium (Hf), tantalum (Ta), tungsten (W), rhenium (Re), osmium (Os), iridium (Ir), platinum (Pt), gold (Au), mercury (Hg), actinium (Ac), rutherfordium (Rf), dubnium (Db), seaborgium (Sg), bohrium (Bh), hassium (Hs), meitnerium (Mt), darmstadtium (Ds), roentgenium (Rg)) and/or group III metals (i.e. boron (B), aluminum (Al), gallium (Ga), indium (In), and thallium (Tl)) or group II metals of the periodic table of elements. In various embodiments, the multivalent metal ions comprise calcium ions and the corresponding multivalent salts used to prepare the capsules comprise calcium salts (e.g., calcium chloride).

In various embodiments, the multivalent ions/salt are present at a concentration of no more than about 20 mM, no more than about 18 mM, no more than about 16 mM, no more than about 14 mM, no more than about 12 mM, or no more than about 10 mM. The multivalent ions/salt may be present at a concentration of from about 0.1 mM to about 10 mM, from about 0.2 mM to about 9.5 mM, from about 0.3 mM to about 9 mM, from about 0.4 mM to about 8.5 mM, from about 0.5 mM to about 8 mM, from about 0.6 mM to about 7.5 mM, from about 0.7 mM to about 7 mM, from about 0.8 mM to about 6.5 mM, from about 0.9 mM to about 6 mM, from about 1.0 mM to about 5.5 mM, from about 1.5 mM to about 5 mM, from about 2.0 mM to about 4.5 mM, from about 2.5 mM to about 4 mM, or from about 3.0 mM to about 3.5 mM.

In various embodiments where the multivalent ions/salt comprises divalent ions, the multivalent ions/salt are present at a concentration of from about 3 mM to about 10 mM, from about 4 mM to about 9 mM, from about 5 mM to about 8 mM, or from about 6 mM to about 7 mM. In various embodiments, the divalent ions/salt (e.g., calcium chloride) are present at a concentration of from about 4 mM to about 6 mM (or from about 0.004 mol/L to about 0.006 mol/L). In various embodiments, the trivalent ions/salt are present at a concentration of from about 0.2 mM to about 4 mM.

In various embodiments, capsule formation is dependent on the ionic strength of the multivalent salt solution. In various embodiments, the ionic strength provided by the range of concentration described above for divalent ions may be used for other metal ions with different charges and hence molarity may be different for salts of differently charged metal ions, and may be determined accordingly. For example, the ionic strength of a multivalent salt solution comprising a combination of multivalent metal cations (e.g., trivalent cations) and monovalent anions may fall within the range of ionic strengths derived from a multivalent salt solution comprising from about 0.004 mol/L to about 0.006 mol/L of a combination of divalent metal cations and monovalent anions. Accordingly, it will be appreciated that a person skilled in the art is able to calculate the concentration of a multivalent salt solution comprising a combination of multivalent metal cations (e.g., trivalent cations) and monovalent anions that is required to fall within the range of ionic strengths derived from a multivalent salt solution comprising from about 0.004 mol/L to about 0.006 mol/L of a combination of divalent metal cations and monovalent anions.

In various embodiments, the slurry further comprises a cation derived from the use of a basic pH adjusting agent to raise the pH of the slurry or neutralise the slurry. The cation(s) derived from the use of a basic pH adjusting agent in the slurry may be from about 0.001 wt % to about 0.020 wt %, from about 0.002 wt % to about 0.019 wt %, from about 0.003 wt % to about 0.018 wt %, from about 0.004 wt % to about 0.017 wt %, from about 0.005 wt % to about 0.016 wt %, from about 0.006 wt % to about 0.015 wt %, from about 0.007 wt % to about 0.014 wt %, from about 0.008 wt % to about 0.013 wt %, from about 0.009 wt % to about 0.012 wt %, from about 0.0091 wt % to about 0.011 wt %, from about 0.0092 wt % to about 0.0109 wt %, from about 0.0093 wt % to about 0.0108 wt %, from about 0.0094 wt % to about 0.0107 wt %, from about 0.0095 wt % to about 0.0106 wt %, from about 0.0096 wt % to about 0.0105 wt %, from about 0.0097 wt % to about 0.0104 wt %, from about 0.0098 wt % to about 0.0103 wt %, from about 0.0099 wt % to about 0.0102 wt %, or from about 0.0100 wt % to about 0.0101 wt % of the slurry. In various embodiments, the slurry comprises about 0.09 g/kg or about 0.009 wt % of ammonium ions. The cation may be ammonium ion (NH₄⁺) derived from ammonia or calcium ion (Ca²⁺) from calcium hydroxide. For example, when a base such as ammonia is used as the pH adjusting agent to raise the pH of the slurry from an acidic pH to a pH that is closer to neutral pH, the resulting ammonia salt obtained may dissociate in the slurry to give ammonium cations. The inventors have found that using an alkali such as ammonia to neutralize the acidic pH of the slurry of capsules initially obtained can aid the eventual skim coating to be substantially defect-free while preventing any negative impact to the strength of the skim coat. In various embodiments, the amount of pH adjusting agent is added in a small/low volume and just sufficient to neutralize the pH of the slurry. Therefore, although it is believed that the strength of the skim coating will be lowered if it contains a high amount of monovalent ions (such as ammonium), it will be appreciated that presence of monovalent ions (derived from pH adjusting agent used) does not adversely affect the strength of the eventual skim coating since such monovalent ions are present in low amounts.

In various embodiments, the slurry comprises water. The water content in the slurry may be from about 30 wt % to about 80 wt %, from about 35 wt % to about 75 wt %, from about 40 wt % to about 70 wt %, from about 45 wt % to about 65 wt %, from about 50 wt % to about 60 wt %, or about 55 wt % of the slurry. Advantageously, the inventors have also surprising found out that the capsules in a slurry format (e.g. robust microencapsulated PCM suspended in water) instead of powder form was beneficial as formulation of the composition with capsule in the powder format was not effective in preparing a skin coat that is defect free.

Cementitious materials are one of the principal ingredients that make up the concrete mixture. Cementitious material includes, but are not limited to, calcium silicates (e.g. tricalcium silicate, dicalcium silicate), aluminosilicates, calcium aluminates (e.g. tricalcium aluminate), calcium aluminoferrite (e.g. tetra-calcium alumino ferrite), or cement (e.g. hydraulic cement such as Portland cement) or the like or combinations thereof. In various embodiments, the cementitious binder portion of the composition comprises a cement, e.g. a hydraulic cement such as Portland cement. Portland cement may be made of a few primary substances, including limestone, sand and/or calcium carbonate or clay, bauxite, and iron ore. It may also include shells, chalk, marl, shale, slag, and slate. The chemical composition of Portland cement comprises four main compounds: tricalcium silicate (3CaO·SiO₂), dicalcium silicate (2CaO·SiO₂), tricalcium aluminate (3CaO·Al₂O₃), and a tetra-calcium aluminoferrite (4CaO·Al₂O₃Fe₂O₃). In various embodiments, the cementitious binder is present at an amount from about 20 wt % to about 60 wt %, from about 25 wt % to about 55 wt %, from about 30 wt % to about 50 wt %, or from about 35 wt % to about 45 wt % based on the dry weight of the composition. The cementitious binder may be present at an amount from about 40 wt % based on the dry weight of the composition.

In various embodiments, the composition further comprises diatomite. Advantageously, the addition of diatomite was found to favourably increase the strength of the composition and the resulting skim coating. Alternative additives such as metakolin were not effective in achieving similar results when used in lieu of diatomite. Without being bound by theory, it is believed that the unique porous structure and fine powder nature of diatomite may be creating more compatible environment for silica shell of the PCM capsules.

In various embodiments, the diatomite is present at an amount from about 5 wt % to about 25 wt %, from about 6 wt % to about 24 wt %, from about 7 wt % to about 23 wt %, from about 5 wt % to about 22 wt %, from about 5 wt % to about 21 wt %, from about 5 wt % to about 20 wt %, from about 6 wt % to about 17 wt % or from about 7 wt % to about 15 wt % based on the dry weight of the composition.

In various embodiments, the composition further comprises latex. Advantageously, the addition of latex improves the adhesion and workability of the composition and the resulting skim coating. The latex may be in the form of dispersible latex powder. The latex may include, but is not limited to acrylic latex, styrene latex, butadiene latex or mixtures thereof. The latex may be present at an amount of from about 1.0 wt % to about 5.0 wt %, from about 1.1 wt % to about 2.9 wt %, from about 1.2 wt % to about 2.8 wt %, from about 1.3 wt % to about 2.7 wt %; from about 1.4 wt % to about 2.6 wt %, from about 1.4 wt % to about 2.5 wt %, from about 1.5 wt % to about 2.5 wt %, from about 1.6 wt % to about 5.0 wt %, from about 1.7 wt % to about 4.0 wt %, from about 1.8 wt % to about 3.0 wt %, from about 1.9 wt % to about 2.0 wt % based on the dry weight of the composition.

In various embodiments, the composition further comprises an organic polymer. Examples of organic polymer include but are not limited to natural organic polymers and synthetic organic polymers, Organic natural polymers include powders such as cellulose, lignin and gelatin. Examples of synthetic organic polymer include but are not limited to poly(vinyl alcohol) (PVA), polyethylene glycol (PEG), polyvinylpyrrolidone (PVP). Advantageously, the addition of a polymer (e.g., organic polymer such as cellulose) improves setting time. Advantageously, the polymer (e.g., organic polymer such as cellulose) may improve water retention in cement, increase drying time to allow hydration reaction occurred completely for fast hardness/strength development, thereby reducing the cracks formulation during drying. The cellulose may be a cellulose that is obtained through etherification of hydroxyl group of cellulose with methyl, hydroxyethyl, hydroxypropyl, and hydrophobes e.g., hydroxyethyl cellulose. The organic polymer may be present at an amount of from about 0.05 wt % to about 0.5 wt %, from about 0.06 wt % to about 0.4 wt %, from about 0.07 wt % to about 0.3 wt %, from about 0.08 wt % to about 0.2 wt %, or from about 0.09 wt % to about 0.15 wt % based on the dry weight of the composition. The organic polymer may be present at an amount of from about 0.1 wt % based on the dry weight of the composition.

In various embodiments, the composition further comprises a filler. Fillers may include, but are not limited to, sand, calcium carbonate, alumina hydrates, silica fume, fly ash, raw mill dust, ground perlite, ground vermiculite or the like or combinations thereof. In various embodiments, the filler comprises sand and/or calcium carbonate. In various embodiments, the filler is present at an amount from about 5 wt % to about 55 wt %, from about 6 wt % to about 54 wt %, from about 7 wt % to about 53 wt %, from about 8 wt % to about 52 wt %, from about 9 wt % to about 51 wt %, from about 10 wt % to about 50 wt %, from about 5 wt % to about 45 wt % or from about 5 wt % to about 40 wt % based on the dry weight of the composition.

In various embodiments, the composition further comprises graphite. Advantageously, graphite increases strength and fire resistance of the composition and the resulting skim coating. The graphite may be expanded graphite. The graphite may be present at an amount of from about 0.5 wt % to about 2.0 wt %, from about 0.6 wt % to about 1.9 wt %, from about 0.7 wt % to about 1.8 wt %, from about 0.8 wt % to about 1.7 wt %, from about 0.9 wt % to about 1.6 wt %, from about 1.0 wt % to about 1.5 wt %, from about 1.1 wt % to about 1.4 wt %, or from about 1.2 wt % to about 1.3 wt % based on the dry weight of the composition.

In various embodiments, the composition comprises diatomite and filler at a ratio of from about 1:3 to about 1:1, from about 1:2.9 to about 1:1.5, from about 1:2.8 to about 1:2; from about 1:2.7 to about 1:2.1; from about 1:2.6 to about 1:2.2; or from about 1:2.5 to about 1:2.3. In one embodiment, the ratio of diatomite to filler is about 1:2.4.

In various embodiments, the composition is an aqueous composition. The total water content of the composition may be from about 5 wt % to about 50 wt % or from about 20 wt % to about 40 wt % of the composition.

Other additives such as performance enhancing additives not mentioned above may also be added to the composition. For example, plasticizers, retarders and/or accelerators may also be included to influence the performance of the composition e.g. to form hard skim coat without cracks. Commercially available additives may also be added to the composition. The total amount of such additional additives that may be added to composition range from about 0.01 wt % to about 2 wt %, about 0.02 wt % to about 1.90 wt %, from about 0.03 wt % to about 1.80 wt %, from about 0.04 wt % to about 1.70 wt %, from about 0.05 wt % to about 1.60 wt %, from about 0.06 wt % to about 1.50 wt %, from about 0.07 wt % to about 1.40 wt %, from about 0.08 wt % to about 1.30 wt %, from about 0.09 wt % to about 1.20 wt %, from about 0.10 wt % to about 1.10 wt %, from about 0.11 wt % to about 1.00 wt %, from about 0.12 wt % to about 0.95 wt %, from about 0.13 wt % to about 0.90 wt %, from about 0.14 wt % to about 0.85 wt %, from about 0.15 wt % to about 0.80 wt %, from about 0.16 wt % to about 0.75 wt %, from about 0.17 wt % to about 0.70 wt %, from about 0.18 wt % to about 0.65 wt %, from about 0.19 wt % to about 0.60 wt %, from about 0.20 wt % to about 0.55 wt %, from about 0.21 wt % to about 0.50 wt %, from about 0.22 wt % to about 0.45 wt %, from about 0.23 wt % to about 0.40 wt %, from about 0.24 wt % to about 0.35 wt %, from about 0.25 wt % to about 0.30 wt %, based on the dry weight of the composition.

In some embodiments, the composition of any one of the preceding claims comprising from 10 wt % to 30 wt % of capsules based on the dry weight of the composition; from 30 wt % to 50 wt % of cement based on the dry weight of the composition; from 10 wt % to 50 wt % of sand and/or calcium carbonate based on the dry weight of the composition; from 5 wt % to 20 wt % of diatomite based on the dry weight of the composition; from 1 wt % to 5 wt % of latex based on the dry weight of the composition; from 0.05 wt % to 0.5 wt % of cellulose based on the dry weight of the composition; from 5 wt % to 50 wt % total water content of the composition; and optionally from 0.1 wt % to 1 wt % of performance enhancing additives based on the dry weight of the composition. Advantageously, the combination of diatomite (for strength—other additives such as metakaolin and calcium carbonate fine powder did not provide these benefits), expanded graphite (for strength and fire resistance), dispersible latex powder (for adhesion and workability), a hydroxy ethyl cellulose (to improve the setting time) was found to provide a defect free and workable skim coat with good adhesion.

In various embodiments, the composition is suitable for preparing a skim coating or skim coat formulation with a thickness of from about 2 mm to about 20 mm, from about 3 mm to about 19 mm, from about 4 mm to about 18 mm, from about 5 mm to about 17 mm, from about 6 mm to about 16 mm, from about 2 mm to about 15 mm, from about 2 mm to about 14 mm, from about 2 mm to about 13 mm, from about 2 mm to about 12 mm, from about 2 mm to about 11 mm or from about 2 mm to about 10 mm. Advantageously, a skim coat with sufficient thickness and PCM content is required to achieve sufficient temperature regulating functionality in building interiors.

### Method

In various embodiments, there is provided a method of preparing the composition of disclosed herein, the method comprising: providing a slurry of capsules, the capsules having shells comprising silica and said shells encapsulating phase change materials (PCM); and optionally mixing the slurry of capsules with a cementitious binder. Embodiments of the disclosed method is a compatible method to produce and formulate PCM capsules in skim coat. In such a coating, the loading of capsules may be higher compared to conventional coatings to provide ambience in buildings and energy saving for urban sustainability.

The step of providing the slurry of capsules may comprise adding a silica precursor to emulsified droplets of PCM in the presence of salt and alcohol to enhance silica growth around the emulsified droplets, thereby forming the slurry of capsules having shells comprising silica and encapsulating PCM. Advantageously, the method is capable of producing capsules having strengthened shells comprising silica. The strengthened shells may be more resistant to stress as compared to the shells of capsules produced by a method devoid of the combined use of salt and alcohol. For example, the strengthened shells may be more resistant to stress as compared to the shells of capsules produced by a method using salt without alcohol or using alcohol without salt or not using both alcohol and salt. Advantageously, embodiments of the disclosed method provide a robust, scalable (easy to scale up), simple, low toxicity, environmentally sustainable (no polymer used to encapsulate the PCM) and cost-effective way to encapsule PCM. Even more advantageously, embodiments of the method are compatible with different PCMs with low water solubility.

In various embodiments, the salt comprises an inorganic salt. In some embodiments, the inorganic salt comprises a metal salt. The salt may be a multivalent (e.g., divalent or trivalent) salt. In some embodiments, the salt comprises a calcium salt, an aluminium salt and the like and combinations thereof. In some embodiments, the salt comprises calcium chloride, aluminium chloride or combinations thereof. In some embodiments, the salt is a calcium salt. Advantageously, multivalent salts (e.g., calcium salts such as calcium chloride) may be especially useful for coating on cements as compared to monovalent salts (e.g., sodium salts).

In various embodiments, the salt is present at a concentration of no more than about 20 mM, no more than about 18 mM, no more than about 16 mM, no more than about 14 mM, no more than about 12 mM, or no more than about 10 mM. The salt may be present at a concentration of from about 0.1 mM to about 10 mM, from about 0.2 mM to about 9.5 mM, from about 0.3 mM to about 9 mM, from about 0.4 mM to about 8.5 mM, from about 0.5 mM to about 8 mM, from about 0.6 mM to about 7.5 mM, from about 0.7 mM to about 7 mM, from about 0.8 mM to about 6.5 mM, from about 0.9 mM to about 6 mM, from about 1.0 mM to about 5.5 mM, from about 1.5 mM to about 5 mM, from about 2.0 mM to about 4.5 mM, from about 2.5 mM to about 4 mM, or from about 3.0 mM to about 3.5 mM. In various embodiments where the salt comprises a divalent salt, the salt is present at a concentration of from about 3 mM to about 10 mM, from about 4 mM to about 9 mM, from about 5 mM to about 8 mM, or from about 6 mM to about 7 mM. In one embodiment, the divalent ions are present at a concentration of from about 4 mM to about 6 mM. In one embodiment, the trivalent ions are present at a concentration of from about 0.2 mM to about 4 mM. Advantageously, limiting the concentration of the salt to no more than about 10 mM may prevent problems that may result during capsule formation such as incomplete shell formation.

In various embodiments, the alcohol is selected from the group consisting of: methanol, ethanol, propanol, isopropanol and the like and combinations thereof. The type of alcohol that may be suitably used may depend on the type of silica precursor used.

In various embodiments, the co-solvent or the alcohol is present at a concentration of at least about 15%, at least about 16%, at least about 17%, at least about 18%, at least about 19%, at least about 20%, at least about 21%, at least about 22%, at least about 23%, at least about 24%, at least about 25%, of at least about 26%, at least about 27%, of at least about 28%, at least about 29% or at least about 30% v/v (volume/volume). In some embodiments, the co-solvent or the alcohol is present at a concentration of at least about 20% v/v. In some embodiments, the co-solvent or the alcohol is present at a concentration of from about 20% to about 30% v/v, from about 23% to about 28% v/v, or from about 25% to about 27% v/v. In one embodiment, the co-solvent or the alcohol is present at a concentration of about 25% v/v. In one embodiment, the co-solvent or the alcohol is present at a concentration of about 26% v/v. In some embodiments, the concentration of the co-solvent or the alcohol is not so high such that any hydrophobic active material present becomes partially soluble.

In various embodiments, the step of adding a silica precursor to emulsified droplets is carried out in an acidic pH environment. In various embodiments, the acidic pH environment comprises a pH of no more than about 7, no more than about 6, no more than about 5, no more than about 4.9, no more than about 4.8, no more than about 4.7, no more than about 4.6, no more than about 4.5, no more than about 4.4, no more than about 4.3, no more than about 4.2, no more than about 4.1, no more than about 4.0, no more than about 3.9, no more than about 3.8, no more than about 3.7, no more than about 3.6, no more than about 3.5, no more than about 3.4, no more than about 3.3, no more than about 3.2, no more than about 3.1, no more than about 3.0, no more than about 2.9, no more than about 2.8, no more than about 2.7, no more than about 2.6, no more than about 2.5, no more than about 2.0, no more than about 1.5, or no more than about 1.0. In some embodiments, the acidic pH is from about pH 2 to about pH 5, from about pH 2.5 to about pH 4.5, from about pH 2.8 to about pH 4.5, from about pH 2.8 to about pH 3.5 or from about pH 3.0 to about pH 3.2. In one embodiment, the acidic pH is about pH 3.0. In one embodiment, the acidic pH is about pH 3.1.

In one embodiment, an acid is provided to establish the acidic pH environment. In some embodiments, the acid comprises an inorganic acid. In some embodiments, the acid comprises a strong acid. In various embodiments, the acid is selected from the group consisting of hydrochloric acid, sulfuric acid, phosphoric acid, nitric acid and combinations thereof. In one embodiment, the acid comprises hydrochloric acid.

In various embodiments, the silica precursor comprises a tetraalkyl orthosilicate, a trialkoxyalkylsilane or a silicon alkoxide (alkoxy silane). In various embodiments, the silica precursor is selected from the group consisting of tetramethyl orthosilicate (TMOS), tetraethyl orthosilicate (TEOS), tetrapropyl orthosilicate (TPOS), methyltrimethoxysilane (MTMS), methyltriethoxysilane (MTES) and the like and combinations thereof. In some embodiments, the silica precursor comprises an alkoxy silane. In one embodiment, the alkoxy silane comprises TEOS.

In various embodiments, the amount of silica precursor added/infused is from about 1% to about 20% v/v, from about 5% to about 20% v/v or from about 8% to about 16% v/v. In various embodiments, the amount of silica precursor added is about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, or about 20% v/v. The silica precursor may be added by way of a continuous flow or a pulsed flow e.g., by use of a syringe pump. In various embodiments, the silica precursor is delivered at a rate of about 0.1 mL/min, about 0.2 mL/min, about 0.3 mL/min, about 0.4 mL/min, about 0.5 mL/min, about 0.6 mL/min, about 0.7 mL/min, about 0.8 mL/min, about 0.9 mL/min, about 1 mL/min, about 2 mL/min, about 3 mL/min, about 4 mL/min, about 5 mL/min, about 6 mL/min, about 7 mL/min, about 8 mL/min, about 9 mL/min, about 10 mL/min, about 0.1 mL/hr, about 0.2 mL/hr, about 0.3 mL/hr, about 0.4 mL/hr, about 0.5 mL/hr, about 0.6 mL/hr, about 0.7 mL/hr, about 0.8 mL/hr, about 0.9 mL/hr or about 1 mL/hr.

In various embodiments, the salt used in the method comprises a multivalent metal salt, the silica precursor used in the method comprises an alkoxy silane and the alcohol used in the method is selected from the group consisting of: methanol, ethanol, propanol, isopropanol and combinations thereof.

In various embodiments, the method further comprises a step of emulsifying the PCM to form emulsified droplets comprising the PCM prior to adding the silica precursor. The PCM may be an oil, an organic solvent, a non-polar substance/solvent or contained therein. In various embodiments, the emulsifying step comprises providing a first phase comprising PCM, and a second phase that is immiscible with the first phase. In some embodiments, the first phase comprises an oil phase, an organic phase or a non-polar phase and the second phase comprises an aqueous phase or a polar phase. In some embodiments, the first phase comprises an aqueous phase or a polar phase and the second phase comprises an oil phase or an organic phase or a non-polar phase.

A surfactant may be provided during the emulsifying step to homogenize the first phase with the second phase. For example, a neutral surfactant such as one containing sugar-based or polyethylene glycol-based hydrophilic groups may be provided. In one embodiment, Triton X-100 is provided as a surfactant. In one embodiment, cetyltrimethylammonium bromide or cetrimonium bromide (CTAB) is provided as a surfactant. It will be appreciated that other suitable surfactants in appropriate amounts/concentrations may also be used to produce surfactant-stabilised microspheres.

A stabiliser (that is not the surfactant) may also be added during the emulsifying step to homogenize the first phase with the second phase. In one embodiment, poly vinyl alcohol is provided as a stabiliser. It will be appreciated that other suitable stabilisers may also be used.

In various embodiments, the emulsifying step is carried out under high pressure. In some embodiments, the emulsifying step comprises passing a mixture of the first phase and the second phase through a homogeniser, optionally a high pressure homogeniser, one or more times until a desirable size of the emulsified droplets is obtained. Prior to the passing step, the mixture of the first phase and the second phase may be subjected to mechanical and/or high shear mixing. In some embodiments, the mixture is subjected to stirring at a speed of at least about 400 rpm, at least about 500 rpm, at least about 600 rpm, at least about 700 rpm, at least about 800 rpm, at least about 900 rpm, at least about 1000 rpm, at least about 2000 rpm, at least about 3000 rpm, at least about 4000 rpm, at least about 5000 rpm, at least about 6000 rpm or at least about 7000 rpm. In various embodiments, the mixture is subjected to stirring until a desirable size of the emulsified droplets is obtained. In various embodiments, the mixture is subjected to stirring for at least about 1 h, at least about 1.5 h, at least about 2 h, at least about 2.5 h, at least about 3 h, at least about 3.5 h, at least about 4 h, at least about 4.5 h or at least about 5 h to obtain the desirable size of the emulsified droplets. Advantageously, embodiments of the method produce a uniform emulsion of PCM to be encapsulated. In various embodiments therefore, the emulsified droplets are provided in the form of a stable emulsion of PCM droplets.

In some embodiments, the polar phase comprises a water-alcohol mixture. In one embodiment, the water-alcohol mixture comprises a water-ethanol mixture. In one embodiment, the water-alcohol mixture comprises a water-isopropanol-ethanol mixture. In some embodiments, the method is carried out using water as the primary medium. The water may be deionized water. In some embodiments, water is the primary medium and the only other main additive that is used is alcohol. In some embodiments, the alcohol is non-toxic and approved for clinical use. Advantageously, embodiments of the method do not require expensive agents and are environmentally friendly.

In various embodiments, the ratio of the first phase comprising the PCM to the second phase comprising an aqueous phase or polar phase is from about 1:99 to about 50:50 by concentration/volume. In various embodiments, the appropriate range of volume of the first phase comprising the PCM to the volume of the second phase comprising an aqueous phase or polar phase (i.e. the volume ratio) is inversely related to one or more of the following: the viscosity of the first phase, the hydrophobicity of the first phase, the efficiency of the surfactant and the desirable size of the emulsified droplets. Where a stabiliser is used, the combined viscosity of the first phase with the stabiliser and the combined hydrophobicity of the first phase with the stabiliser may be considered. In one embodiment, the volume ratio of the first phase comprising the PCM to the second phase comprising an aqueous phase or polar phase is no more than about 50:50 such that gel formation is avoided. In some embodiments, the volume ratio of the first phase comprising the PCM to the second phase comprising an aqueous phase or polar phase is from about 1:99 to about 15:85 (or 1-15% v/v dispersion of first phase in second phase) when the desirable size of the emulsified droplets is about 5 μm or less. In some embodiments, the volume ratio of the first phase comprising the PCM to the second phase comprising an aqueous phase or polar phase is from about 15:85 to about 50:50 (or 15-50% v/v dispersion of first phase in second phase) when the desirable size of the emulsified droplets is about 5 μm or more, or from about 5 μm to about 80 μm. Advantageously, by varying a ratio of the first phase to the second phase (in addition to varying a number of passes through a homogeniser), the size of the emulsified droplets acting as the template may be controlled and hence the size of the capsules may also be easily tuned.

In some embodiments, the method is carried out at the melting temperature of the PCM or at a temperature that is no more than about 10° C. or no more than about 5° C. from the melting temperature. Advantageously, embodiments of the method can be suitably performed at a temperature that is or close to the melting temperature of PCM, thereby enabling high loading of the PCM within the silica capsules.

In some embodiments, the method is devoid of a template removal step comprising calcination. In some embodiments, the method is carried out at a temperature of no more than about 60° C. In some embodiments, the method, including any template removal step, is carried out at a temperature of no more than about 60° C., no more than about 50° C., no more than about 45° C., no more than about 40° C., no more than about 35° C. or no more than about 30° C. In some embodiments, the method is carried out at ambient/room temperature. In some embodiments, the method is carried out at ambient pressure. Advantageously, embodiments of the method do not require high temperature or pressure and are therefore energy-saving and cost-effective. Thus, embodiments of the method may also be suitably used for encapsulating low temperature phase change materials.

In various embodiments, the method further comprises a step of concentrating the capsules. In various embodiments, the concentrating step comprises removing at least a portion of any water/solvent and/or co-solvent/alcohol surrounding the silica capsules. In various embodiments, the concentrating step does not substantially change the ratio of silica to the substance encapsulated by the capsules. In various embodiments, the concentrating step does not result in substantial leakage from the capsules. Advantageously, embodiments of the capsules are able to withstand a concentrating procedure without breakage.

In some embodiments, the method comprises concentrating the capsules to an amount of about 20%, about 21%, about 22%, about 23%, about 24%, about 25%, about 26%, about 27%, about 28%, about 29%, about 30%, about 31%, about 32%, about 33%, about 34%, about 35%, about 36% or about 37% in water. In some embodiments, the capsule is capable of being concentrated in water to a concentration of at least about 25%, about 26%, about 27%, about 28%, about 29%, about 30%, about 31%, about 32%, about 33%, about 34%, about 35%, about 36%, about 37%, about 38%, about 39% or about 40% without substantial breakage. The percentage concentration may be in terms of the weight of the capsules and/or weight of any encapsulated content/volume of water (wt/v %).

In various embodiments, the method further comprises a step of collecting the capsules. Post treatment steps such as purification and separation may also be carried out. In various embodiments, the silica capsules are separated by filtration under vacuum. In various embodiments, the silica capsules are washed or rinsed with water, e.g. fresh warm water, one or more times. Given that embodiments of the method use a small number of reagents, all of which are non-toxic, embodiments of the method require fewer purification and/or separation steps as compared to conventional methods of synthesising silica capsules. Further, embodiments of the method also have greater material efficiency.

In one embodiment, the method is carried out in a reactor.

In various embodiments, the yield of the silica capsules (by a solid content) is at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94% or at least about 95

Embodiments of the method are easy to perform and may be carried out as a one-step direct synthesis method/one pot synthesis method. Embodiments of the method are also environmentally benign and has substantially high reproducibility and/or scalability (good control of size) attributed in part to the robust shells that are produced.

Embodiments of the method are capable of producing capsules having a size/diameter/particle size/particle size distribution/average particle size in the range of from about 100 nm to about 100 μm, from about 100 nm to about 450 nm, from about 100 nm to about 400 nm, from about 100 nm to about 350 nm, from about 100 nm to about 300 nm, from about 100 nm to about 250 nm, from about 100 nm to about 200 nm, from about 100 nm to about 150 nm, from about 500 nm to about 100 μm, from about 1 μm to about 100 μm, from about 100 nm to about 80 μm, from about 1 μm to about 80 μm, from about 1 μm to about 60 μm, from about 1 μm to about 50 μm, from about 1 μm to about 40 μm, from about 1 μm to about 30 μm, from about 1 μm to about 20 μm, from about 1 μm to about 10 μm, from about 1 μm to about 8 μm, from about 8 μm to about 50 μm, from about 8 μm to about 40 μm, from about 8 μm to about 30 μm, from about 8 μm to about 20 μm, from about 8 μm to about 10 μm, no less than about 8 μm, no less than about 9 μm, or no less than about 10 μm, no less than about 20 μm, no less than about 30 μm, no less than about 40 μm or no less than about 50 μm. In various embodiments, the capsules have a size/diameter/particle size/particle size distribution/average particle size in the range of from about 0.15 μm to about 80 μm. In some embodiments, the capsules obtained are micron-sized. In some embodiments, the capsules are submicron-sized. In some embodiments, the capsules are nano-sized. In some embodiments, the capsules are no more than about 100 μm, or no more than about 80 μm. In some embodiments, the capsules are no less than about 150 nm or 0.15 μm, or no less than about 100 nm, or 0.1 μm.

The capsules obtained/produced by the embodiments of the method may remain substantially intact under one of more of mechanical stress, high shear, high temperature, repeated heating and cooling, high shear mixing and large-scale mixing. This is particularly relevant for coating applications, where capsules encapsulating phase change materials etc. are required to undergo repeated heating and cooling cycles and high shear mixing. This is also particularly relevant for skim coating applications, where capsules encapsulating PCMs are required to withstand large thermal energy changes.

In some embodiments, the capsules may remain substantially intact under high vacuum, e.g. during SEM analysis. In some embodiments, the capsules remain substantially intact under one or more of heating, applying vacuum at about 50° C. or concentrating up to at least about 37% by weight in a suspension. In some embodiments, the capsules are substantially devoid of ruptures and/or leakages when observed by a SEM under ×1000 magnification. In some embodiments, the capsules are capable of being subjected to SEM vacuum conditions without substantial breakage. Advantageously, embodiments of the capsules are robust and substantially resistant to breakage or rupture when subjected to harsh treatments.

In various embodiments, the capsules have a high carrying capacity of at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 81%, at least about 82%, at least about 83%, at least about 84%, at least about 85%, at least about 86%, at least about 87%, at least about 88%, at least about 89% or at least about 90% for the PCM. In some embodiments, the capsules have a high carrying capacity of at least about 80%. The percentage concentration may be in terms of the weight of the PCM (wt/v %). In some embodiments, the capsules, when loaded with PCM, have a high solid content with the shell making up about 5% to about 30% or about 10% to about 20% of the total weight of the PCM loaded capsule. In some embodiments, the capsules are capable of being loaded with PCM of at least about 80% by weight of the loaded capsules without substantial breakage.

In various embodiments, the capsules are stable under ambient conditions for no less than about 6 months, no less than about 7 months, no less than about 8 months, no less than about 9 months, no less than about 10 months, no less than about 11 months, or no less than about 12 months. In various embodiments, the capsules do not break or rupture under storage for no less than about 6 months, no less than about 7 months, no less than about 8 months, no less than about 9 months, no less than about 10 months, no less than about 11 months, or no less than about 12 months. In some embodiments, the capsules are stable under ambient conditions for no less than about 6 months without substantial breakage.

In various embodiments, the method further comprising adding a pH adjusting agent to the slurry of capsules obtained to obtain a pH of no less than about 5, no less than a pH of about 5.5, or no less than a pH of about 6. The slurry may have a pH range of from about 5 to about 8, from about 5.1 to about 7.9, from about 5.2 to about 7.8, from about 5.3 to about 7.7, from about 5.4 to about 7.6, from about 5.5 to about 7.5, from about 5.6 to about 7.4, from about 5.7 to about 7.3, from about 5.8 to about 7.2, from about 5.9 to about 7.1, or from about 6 to 7. Thus, in some embodiments there is also provided a composition for skim-coating comprising a slurry of capsules, the capsules having shells comprising silica and said shells encapsulating phase change materials (PCM) and wherein the slurry has a pH of no less than about 5 or any of the pH stated above.

The pH adjusting agent may be a basic pH adjusting agent or a base. Examples of basic pH adjusting agent include but are not limited to, ammonium hydroxides, alkali metal hydroxide (e.g, calcium hydroxide) or ammonia.

Embodiments of the method are capable of producing a stable slurry of capsules encapsulating PCM. In various embodiments, the slurry of capsules is in a stable colloidal formulation. The colloidal formulation may be stable at least under ambient conditions for no less than about 6 months, no less than about 7 months, no less than about 8 months, no less than about 9 months, no less than about 10 months, no less than about 11 months, or for no less than about 12 months. The colloidal formulation may be substantially monodispersed. In various embodiments, the capsules are substantially uniform in shape. In various embodiments, the capsules are substantially spherical in shape. In various embodiments, the concentration of the capsules in the slurry are at least about 10 wt %, at least about 15 wt %, at least about 20 wt %, at least about 25 wt %, at least about 30 wt %, at least about 31 wt %, at least about 32 wt %, at least about 33 wt %, at least about 34 wt %, at least about 35 wt %, at least about 36 wt %, at least about 37 wt %, at least about 38 wt %, at least about 39 wt %, at least about 40 wt %, at least about 45 wt %, at least about 50 wt %, at least about 55 wt %, at least about 60 wt %, at least about 65 wt %, at least about 70 wt %, at least about 75 wt %, at least about 80 wt %, at least about 85 wt %, at least about 90 wt % or about 100 wt %. When the capsules are concentrated, the individual particles may aggregate. In various embodiments, the particles can be dispersed after aggregation, without substantial breakage of the particles. In some embodiments, the capsules coalesce to form cauliflower-like structures at concentrations of about 60 wt % or more.

In various embodiments, the method of preparing the composition further comprises mixing one or more of a filler, diatomite, latex and organic (e.g. natural or synthetic) polymer with the slurry of capsules. The filler, diatomite, latex and/or organic (e.g. natural or synthetic) polymer may have one of more characteristics as earlier described.

In various embodiments, the method of preparing the composition of comprises adding the cementitious binder, the filler, diatomite, latex and the organic (e.g. natural or synthetic) polymer to the slurry of capsules; and optionally adding additional water to the mixture of the cementitious binder, the filler, diatomite, latex, the organic (e.g. natural or synthetic) polymer and capsules, wherein the final composition comprises from 10 wt % to 30 wt % of capsules based on the dry weight of the composition, from 30 wt % to 50 wt % of cementitious binder based on the dry weight of the composition, from 10 wt % to 50 wt % of filler based on the dry weight of the composition, from 5 wt % to 20 wt % of diatomite based on the dry weight of the composition, from 1 wt % to 5 wt % of latex based on the dry weight of the composition, from 0.05 wt % to 0.5 wt % of organic (e.g. natural or synthetic) polymer based on the dry weight of the composition, and from 5 wt % to 50 wt % total water content of the composition.

Advantageously, in various embodiments, the production process of the composition and/or skim coating formulation is an optimised process that reduces waste, resulting in high yield of production.

### BRIEF DESCRIPTION OF FIGURES

FIG. 1 is a schematic diagram 100 for illustrating a method of emulsifying PCM particles to obtain PCM oil/water emulsion (O/W emulsion) with micron sized droplets in accordance with various embodiments disclosed herein. PCM particles 102 are dispersed in a continuous water phase (e.g., water/ethanol (EtOH) 104) in the presence of oil (e.g., surfactant 106) to obtain PCM O/W emulsion with micron sized droplets 108.

FIG. 2 shows an optical microscope image of PCM oil/water emulsion (O/W emulsion) with micron sized droplets. The image is taken at 4× magnification. PCM used is paraffin mixtures (e.g., Pluss OM-28P obtained from Pluss Advanced Technologies Pvt. Ltd). The o/w emulsion is OM28P in EtOH/water solution.

FIG. 3 is a schematic diagram 300 for illustrating a method of forming a silica shell over emulsified PCM micron sized droplets to obtain silica-based PCM microcapsules in accordance with various embodiments disclosed herein. The pH of the PCM O/W emulsion is adjusted, and a silica precursor/solution (sol) (e.g., tetraethyl orthosilicate (TEOS)) 302 is introduced slowly to the emulsion and allowed to undergo hydrolysis and condensation reaction on the surface of the emulsified micron sized droplets to form a silica shell 304 over the PCM 306.

FIG. 4 is a schematic diagram of a silica-based PCM microcapsule in accordance with various embodiments disclosed herein. The silica-based PCM microcapsule 400 comprises a robust silica shell 402 encapsulating a PCM 404.

FIG. 5 shows images of silica-based PCM microcapsules in accordance with various embodiments disclosed herein that are prepared from different PCMs with low water solubility, showing that the microencapsulating process is highly compatible with PCMs with low water solubility. PCMs are prepared in EtOH/H₂O (1:3) mixture. PCM A: Paraffin mixture OM-28P; PCM B: Fatty acid mixture OM-29; PCM C: Fatty acid ester mixture CM29; and PCM D: Fatty acid ester mixture SL28.

FIG. 6 shows SEM images of silica-based PCM microcapsules with smooth surfaces. The top image is taken at 1,000× magnification, with the scale bar representing 10 μm. The bottom image is taken at 2,000× magnification, with the scale bar representing 10 μm.

FIG. 7 shows a SEM image of silica-based PCM microcapsules with rough surfaces. The SEM image is taken at 200× magnification, with the scale bar representing 100 μm.

FIG. 8 shows images of a scale up of PCM encapsulation in accordance with various embodiments disclosed herein.

FIG. 9 shows results obtained from compatibility test performed with cementitious materials. Part (a) shows a sample prepared by mixing 70 wt % cement (binder) with 30 wt % silica-based PCM capsules. Part (b) shows a sample prepared by mixing 70 wt % cement (binder) with 30 wt % commercial polymer encapsulated PCM capsules.

FIG. 10 shows images of initial skim coat formulation prepared by direct mixing of PCM capsule powder. The top 2 images are captured before outdoor exposure tests and the bottom 2 images are captured after 2 weeks of outdoor exposure tests. Images on the left show samples prepared from PCM capsule powder+cement+water. Images on the right show samples prepared from PCM capsule powder+cement+water+graphite.

FIG. 11 shows an image of skim coat sample prepared from a mixture of sieved PCM capsule powder with cement. As shown, the skim coat does not have good adhesion strength. There is loss of adhesion and the skim coat could be peeled off easily from substrates without additives.

FIG. 12 shows an optical microscope image of diatomite powder in water, with the scale bar representing 10 μm. The image is taken at 40× magnification. Porous structure can be observed for diatomite powder in water.

FIG. 13 shows a differential scanning calorimetry (DSC) graph of a skim coat sample prepared with ball milling process.

Part A of FIG. 14 shows an image of a skim coat sample prepared by incorporating PCM capsules using ball milling procedure. Part B of FIG. 14 shows an image of a skim coat sample prepared by incorporating PCM capsules using PCM slurry procedure.

FIG. 15 shows an image of a skim coat sample prepared by adding graphite to the formulation. No obvious change was observed with addition of 1 wt % or 2 wt % graphite.

FIG. 16 shows images of skim coat samples formulated by adding ammonia, cellulose and latex powder. The skim coat samples were observed to harden quickly and remained crack-free.

FIG. 17 shows images of skim coat samples prepared from 2 controls. Control 1 contains fillers and additives while control 2 contains 40 wt % cement and 60 wt % sand.

FIG. 18 shows images of skim coat samples prepared from different PCM capsules content (i.e. 5 wt %, 8 wt % and 10 wt %) respectively.

FIG. 19 shows images of skim coat samples prepared from different PCM capsules content (i.e. 20 wt %, 30 wt % and 40 wt %) respectively.

FIG. 20 is a graph showing the thermal conductivity of skim coats containing different PCM content (i.e. 5 wt % PCM, 8 wt % PCM, 20 wt % PCM, 30 wt % PCM and pure PCM (100 wt %)). The controls used are Control 1 (containing fillers and additives) and Control 2 (containing cement and sand).

FIG. 21 is a graph showing the specific heat capacity (by volume) of skim coats containing different PCM content (i.e. 5 wt % PCM, 8 wt % PCM, 20 wt % PCM and 30 wt % PCM). The controls used are Control 1 (containing fillers and additives) and Control 2 (containing cement and sand).

FIG. 22 is a schematic diagram for illustrating an experimental set up in a laboratory for measuring back surface temperature. A sample 2200 is positioned approximately 35 cm below an infrared (IR) lamp 2202. The temperature of the back surface of sample 2200 is measured (and displayed on temperature sensor/display 2204) by attaching the temperature sensor/display directly to said surface.

FIG. 23 is a graph showing the temperature change over time (or thermal regulation effect) of skim coats containing different PCM content (i.e. 5 wt % PCM, 20 wt % PCM and 30 wt % PCM). The controls used are Control 1 (containing fillers and additives) and Control 2 (containing cement and sand).

FIG. 24 is a schematic diagram for illustrating an experimental set up in a laboratory for measuring air temperature in mini house testing or cool roof house thermal testing. The mini house comprises two compartments 2400 and 2402. The roof 2404 of compartment 2400 is uncoated (i.e. used as a control) while the roof 2406 of compartment 2402 is coated with a thermoshield (i.e. 20 wt % PCM skim coat with a 6 mm thickness). The temperature of air in the interior of compartment 2400 is measured with a temperature sensor 2408. The temperature of air in the interior of compartment 2402 is measured with a temperature sensor 2410 by attaching the temperature sensor directly to the back surface of the roof (i.e. interior).

FIG. 25 is a graph showing the back surface temperature change over time results obtained from the mini house testing or cool roof house thermal testing as illustrated in FIG. 24.

FIG. 26 is a schematic diagram 2600 for illustrating total solar reflectance (TSR) of PCM skim coats prepared in accordance with various embodiments disclosed herein. At step 2602, a robust silica shell 2610 encapsulates a PCM 2608 to form a silica-based PCM microcapsule 2612, which is formulated into a PCM skim coat 2614 at step 2604. Heat (for e.g., exterior heat) is absorbed by the PCM skim coat which leads to lower interior temperature and cooler interior air. At step 2606, the PCM skim coat is further coated with double layer cool coatings 2616 having a thickness of about 100 μm and applied on a drywall 2618.

FIG. 27 shows an image of PCM skim coat that is not coated with cool coatings (on the left) and an image of PCM skim coat further coated with cool coatings (on the right).

FIG. 28 is a graph showing the total solar reflectance (TSR) in % of PCM skim coats containing different PCM content (i.e. 5 wt % PCM, 10 wt % PCM, 20 wt % PCM and 30 wt % PCM) that are not coated with cool coatings. The controls used are two Control 2 (containing cement and sand), one coated with cool coating and one not coated with cool coating.

FIG. 29 is a graph comparing the back surface temperature difference of PCM skim coats containing different PCM content (i.e. 8 wt % PCM and 30 wt % PCM) that are not coated with cool paint with those that are coated with cool paint. The control used is Control 1 (containing fillers and additives) not coated with cool paint.

FIG. 30 shows images of further tests and work to be performed such as outdoor exposure tests and scaling up for large scale field studies.

### EXAMPLES

Example embodiments of the disclosure will be better understood and readily apparent to one of ordinary skill in the art from the following discussions and if applicable, in conjunction with the figures. It should be appreciated that other modifications related to structural, physical and chemical changes may be made without deviating from the scope of the invention. Example embodiments are not necessarily mutually exclusive as some may be combined with one or more embodiments to form new exemplary embodiments. The example embodiments should not be construed as limiting the scope of the disclosure.

### Example 1: Preparation of Silica-based Phase Change Material Microcapsules

### Microencapsulation Technology

Silica-based phase change material (PCM) microcapsules were prepared using microencapsulation technology which comprises 2 steps.

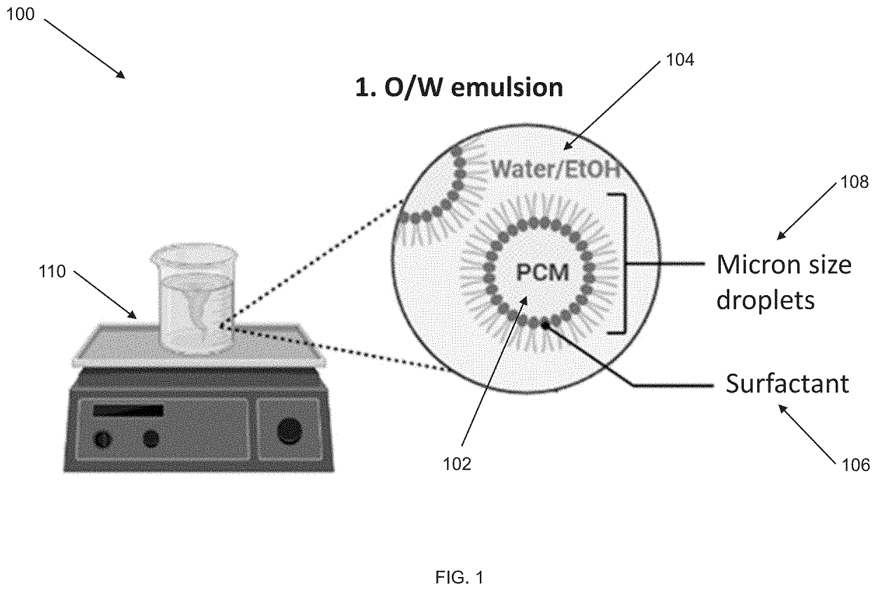

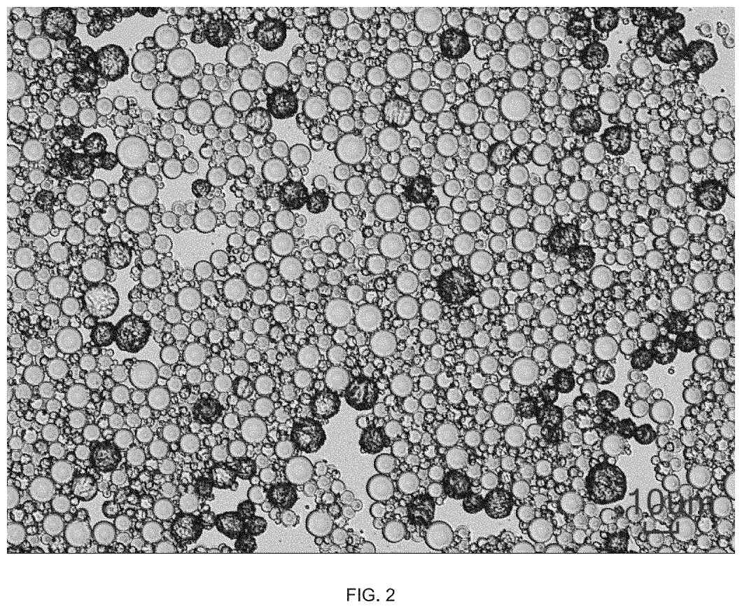

Firstly, as shown in FIG. 1, phase change material (PCM) particles 102 are dispersed in a continuous water phase (e.g., water/ethanol (EtOH) 104) in the presence of oil (e.g., surfactant 106) to obtain PCM oil/water emulsion (O/W emulsion) with micron sized droplets 108. A SEM image of the PCM O/W emulsion showing droplets in micron size is provided in FIG. 2. The surfactant 106 is added to aid in emulsifying PCM particles 102 in water/EtOH 104. The PCM O/W emulsion may also be prepared with a hotplate 110 for temperature control (e.g., heating to an appropriate temperature) and/or mixing (e.g., mechanical stirring).

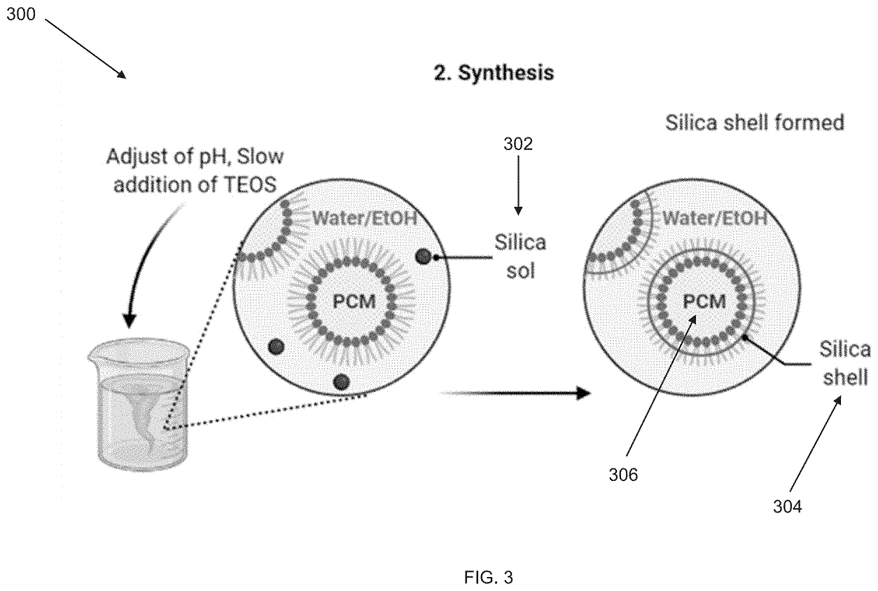

Next, as shown in FIG. 3, the pH of the PCM O/W emulsion is adjusted, and a silica precursor/solution (sol) 302 is introduced slowly to the emulsion and allowed to undergo hydrolysis and condensation reaction on the surface of the emulsified micron sized droplets to form a silica shell 304 over the PCM 306. In this example, tetraethyl orthosilicate (TEOS) was used as the silica precursor/sol.

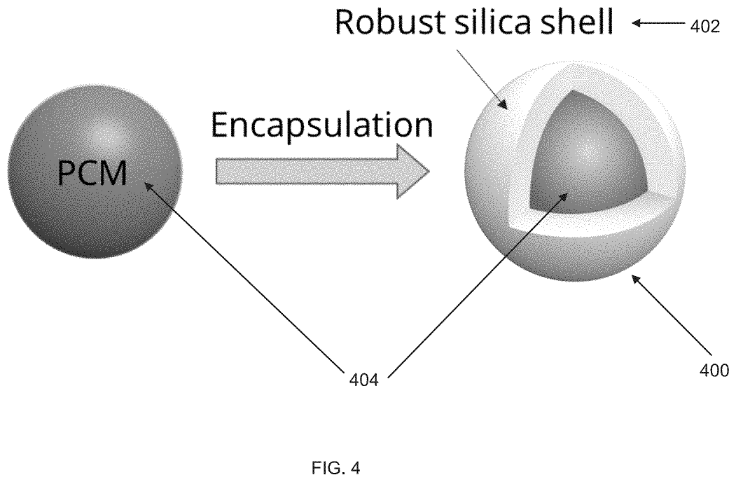

The synthesized silica-based PCM microcapsule 400 comprises a robust silica shell 402 encapsulating a PCM 404 (FIG. 4). The core-shell PCM-silica microcapsules are produced in slurry format, which can be used for the preparation of skim coat formulations later.

The present microencapsulation technology has the following advantages:
Simple process, low toxicity, easy to scale up
Sustainable products—no polymer used
Better compatibility with inorganic cementitious building materials
Robust silica shell

### Highly Compatible Process

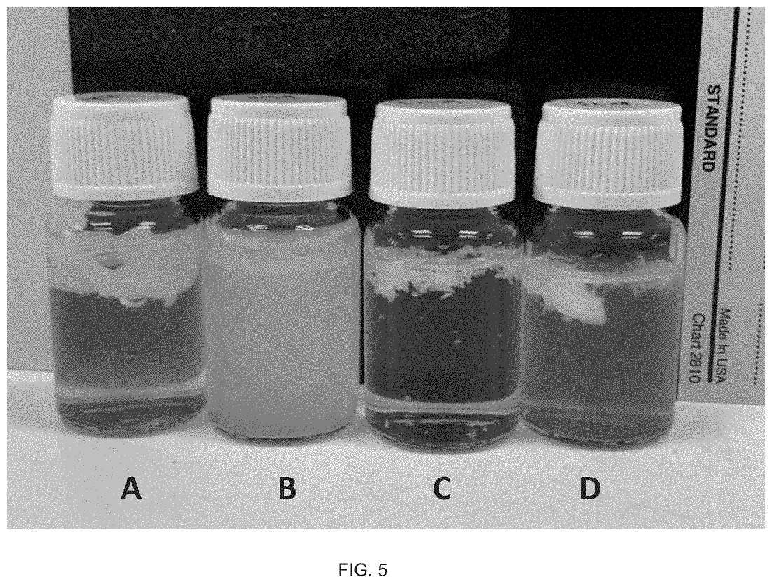

Process is compatible with different PCMs with low water solubility (FIG. 5)
Surface morphology of capsules may change with different PCMs used
Cycling performance can be conducted to check the stability of the microcapsules with different PCMs
   Good capsule:
      no change in appearance of capsules, no oil leak observed after over 2000 cycles
   Bad capsule:
      PCM melted, oily slurry formed

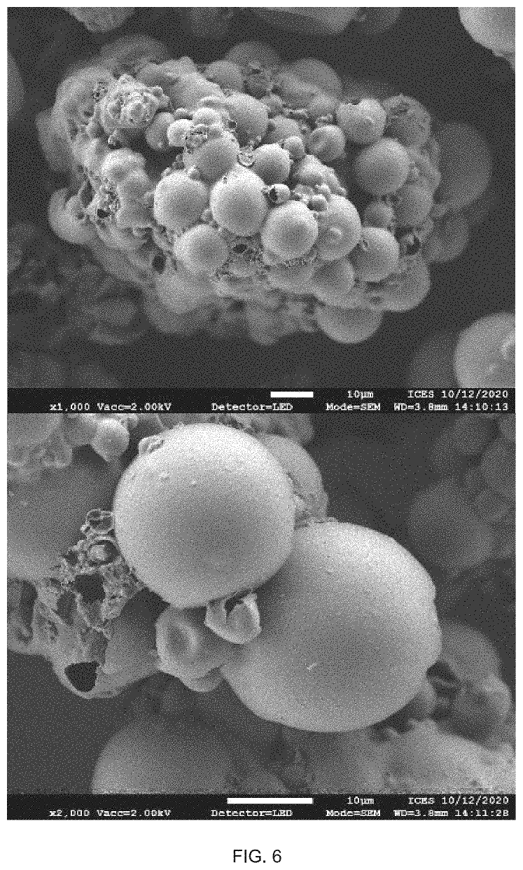

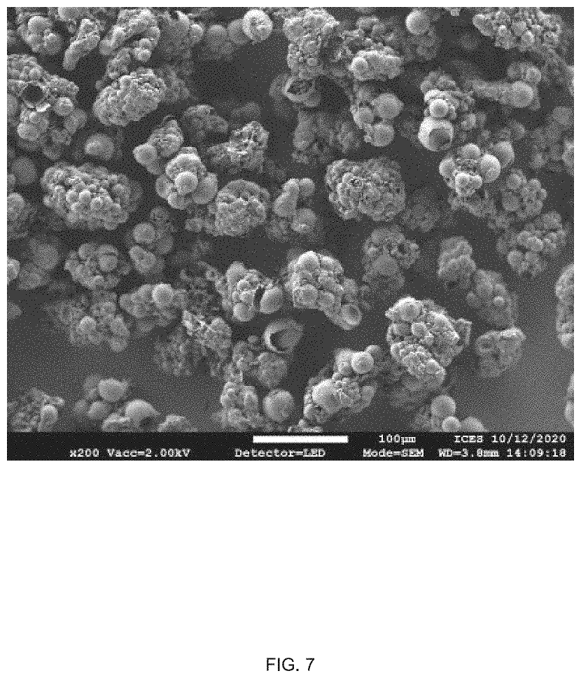

FIG. 6 shows SEM images of silica-based PCM microcapsules with smooth surfaces. FIG. 7 shows a SEM image of silica-based PCM microcapsules with rough surfaces.

### Example 2: Preliminary Studies

Prior to producing a skim-coat formulation, the following background work was performed.

The encapsulation process of different phase change materials (PCMs), namely CrodaTherm™ 29 (CM29) (i.e. fatty acid ester mixtures) obtained from Croda International Plc, savE® OM29 (i.e. fatty acid mixtures) obtained from Pluss Advanced Technologies Pvt. Ltd, OM28p (i.e. paraffin mixtures) obtained from Pluss Advanced Technologies Pvt. Ltd and SL28 (i.e. fatty acid ester mixtures) was tested and confirmed in the lab. CM29 and OM28p were proved to be compatible with encapsulation process. The produce capsules performed well in the cycling performance test.

The reaction parameters were optimized and the reaction time was reduced from 72 hours (hr) to 24 hours (hr) to facilitate the scale-up.

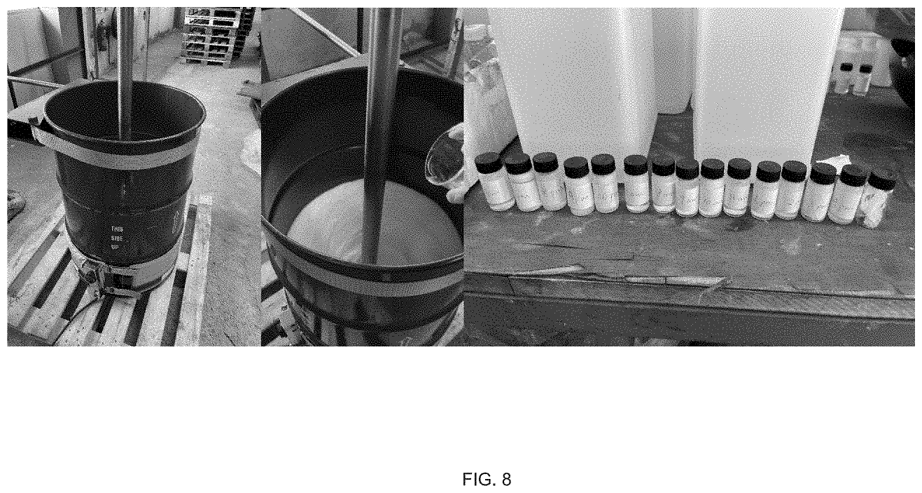

50 litres (L) scale up of CM29 encapsulation was successfully conducted (FIG. 8). 200 L scale up is currently on-going. The scale up was conducted in a coated metal drum with a hotplate at the bottom to control the temperature. A mixer was used to generate stable emulsion and the reactants were added manually. There were some deviations in the scale up operation. For example, the pH of reaction is around 1-2, which is lower than the pH described in the operation procedure earlier provided. Based on analysis, those PCM capsules performed well in the cycling performance tests. They are therefore suitable to be used in skim coat applications. The finished product comprises PCM capsule slurry with 40-45 wt % capsule content. The stable capsules can hold the PCM without leak for over 2,000 heating/cooling cycles.

### Example 3: Initial Evaluation—Compatibility

Compatibility test was performed with cementitious materials by mixing 70 wt % cement (binder) respectively with (a) 30 wt % silica-based PCM capsules; and (b) 30 wt % commercial polymer encapsulated PCM capsules. The commercial PCM is a research sample supplied by Croda International Plc.

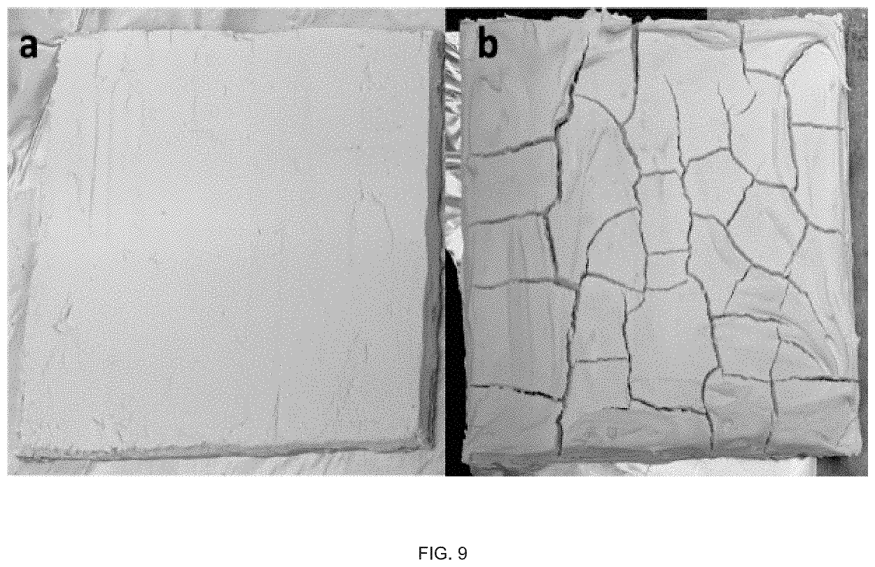

The results from the compatibility tests are shown in FIG. 9. Cracks were observed on the sample prepared from commercial polymer encapsulated PCM capsules (FIG. 9b). On the other hand, the sample prepared from silica-based PCM capsules was relatively free of cracks (FIG. 9a).

### Example 4: Skim Coat Formulation Development

### Direct Mixing of PCM Capsule Powder

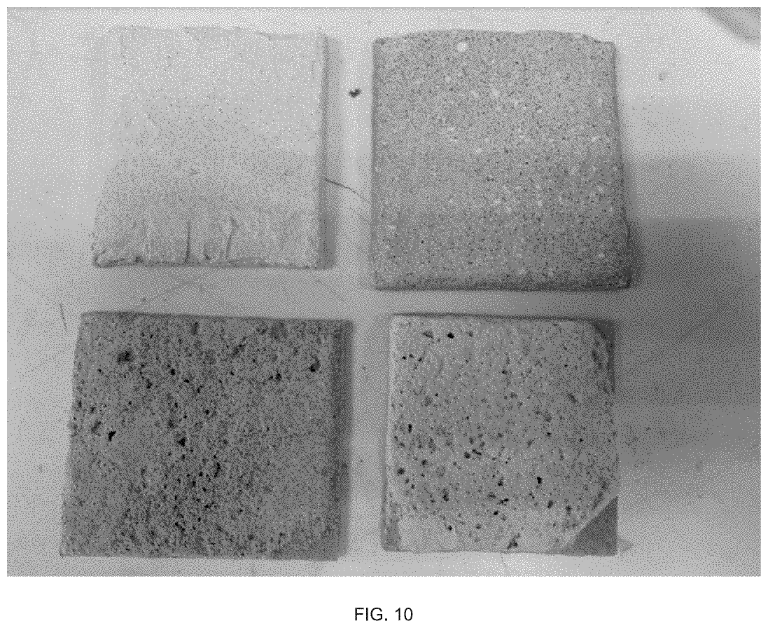

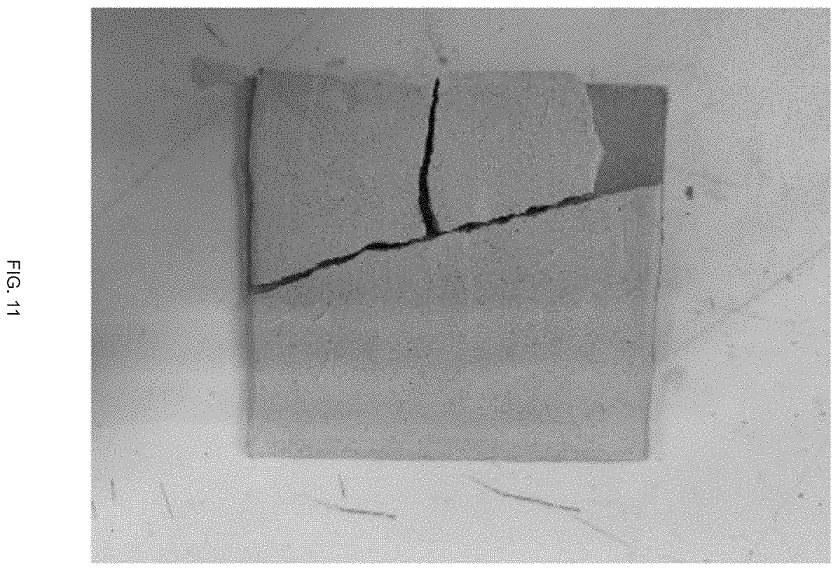

Initially, it was found that if PCM capsule powder is directly used in skim coat, the poor dispersing of PCM in cement matrix will result in weak adhesion between capsule aggregates and matrix. The situation became even worse after outdoor weathering (FIG. 10).

### Use of Sieved PCM Capsule Powder or PCM Slurry

Also, it was found that the skim coat could be easily peeled off from the substrate due to low adhesion strength when sieved PCM capsule powder or the PCM slurry was used to prepare the skim coat (FIG. 11).

### Use of Metakaolin, Diatomite and Calcium Carbonate

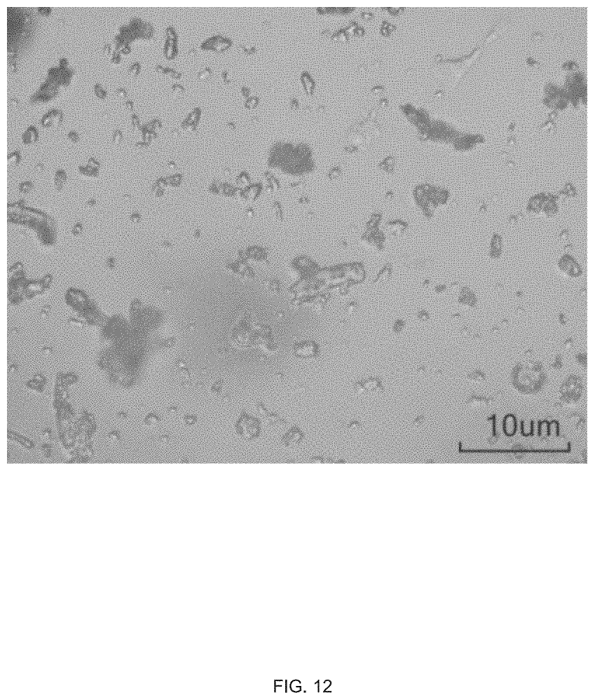

Even though it was believed that Metakaolin can be used to partially replace cement, no obvious improvement was found with the use of Metakaolin in our cases. The formulation was checked/tested with different silicon hydrophobic powder content but it did not show any visible positive effect on the skim coat samples. Diatomite and Calcium carbonate were tested as the filler together with the sand. It was found that diatomite alone can form stable solid bulk material with PCM. Without being bound by theory, it is believed that its porous structure (FIG. 12) can absorb the PCM and prevent PCM leaking at elevated temperature. Therefore, a portion of diatomite is used in the skim coat formulation. Similar experiments were conducted using calcium carbonate. It was found that calcium carbonate does not have this stabilization effect on PCM oil.

### Use of Redispersible Latex Powder

It was found that the use of redispersible latex powder can improve adhesion strength of the skim coat. A ladder test was conducted. It was found that 2% of latex powder can provide sufficient adhesion to the substrate. For the sample above 2% dosage, no substantial effect was observed.

### Use of PCM Capsule Slurry or Ball Milling Device for Incorporation

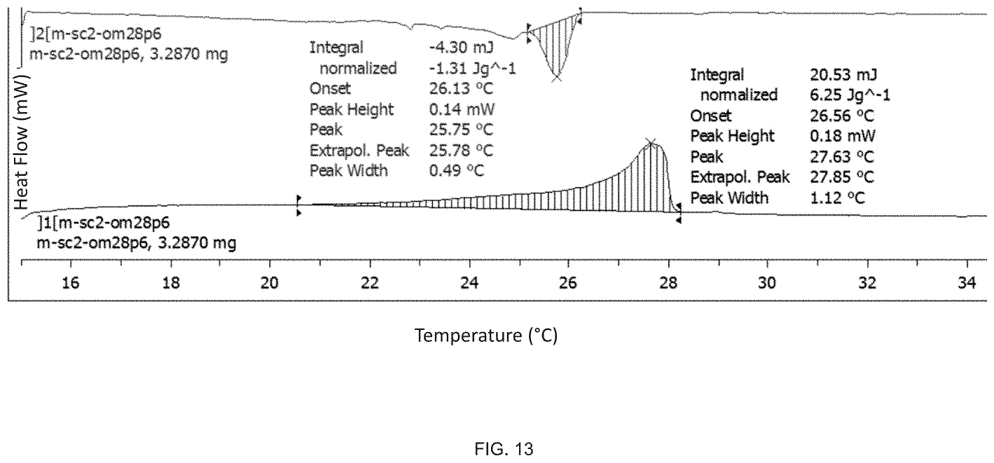

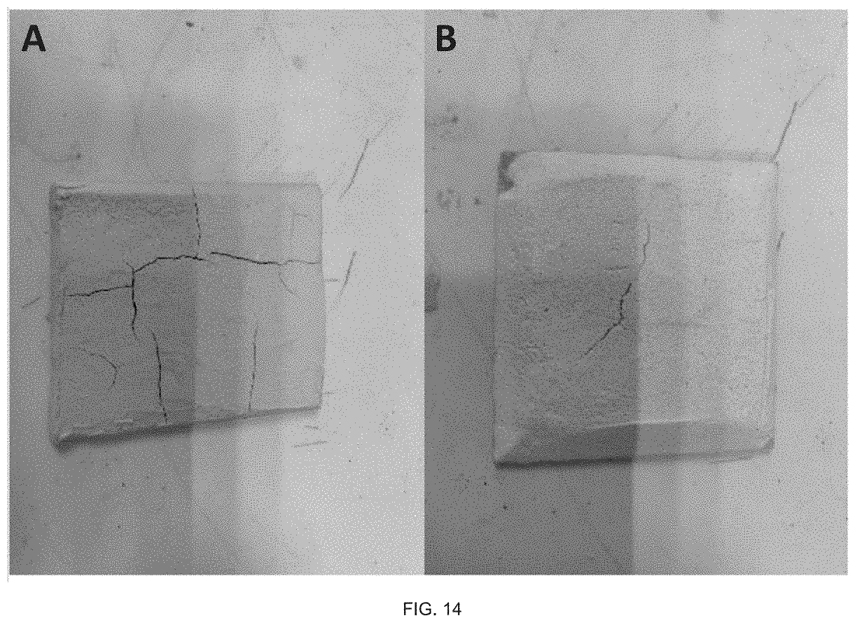

After confirming the effect of additives, different ways to incorporate PCM capsules in the skim coat were attempted, including the use of PCM capsule slurry and the use of ball milling device to incorporate PCM capsule powder. The experiment showed that the use of ball milling device can improve the mixing of PCM with cement, increase overall density and therefore improve the mechanical strength of skim coats. However, it was found that the melting-solidification process of the PCM was somehow affected after the ball milling process, according to the differential scanning calorimetry (DSC) curve (FIG. 13). For the PCM slurry, the mechanical strength of the skim coat is lower than the control sample but it is much better than the initial skim coat samples.

It was also noted that cracks can be observed on sample obtained from ball milling procedure (FIG. 14A) as well as on sample obtained from PCM slurry procedure (FIG. 14B) if additives are not added properly. The steps involved in preparing a skim coat via ball milling procedure are described as follows.
1. Dry PCM capsules powder and diatomite are mixed in a dish and ball-milled.
2. The resulting ball-milled mixture is sieve and added to cement and remaining components of the skimcoat.
3. Add water till it becomes a viscous and cream-like mixture.
4. The mixture is then applied on a board evenly and allow it to dry over few days to obtain a skim coat.

### Use of Graphite

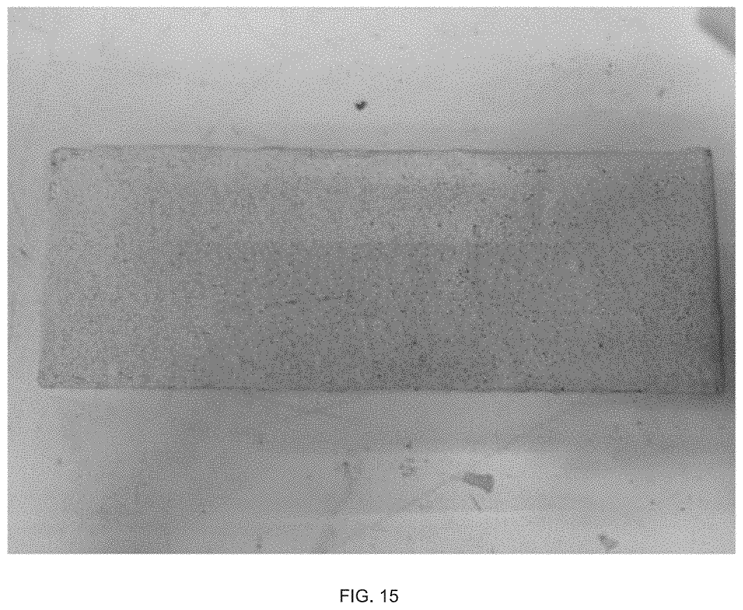

With 1% or 2% graphite, it was noticed that no obvious change was observed (FIG. 15).

### Use of pH Adjusting Agent (e.g., Ammonia) and Cellulose

It was found that capsule slurry is the possible finished product form and removal of ‘wash to neutral pH’ step from PCM capsule manufacturing process was requested in order to reduce cost. The effect of the acid residue on skim coat was then investigated. The skim coats with different PCM capsule content (10%-30%) were found to be weak and full of cracks, when the ‘unwashed’ PCM capsule slurry from an earlier study with a low pH was used, even with the addition of additives. It is believed that the acid can react with the alkaline in the cement, so the pH of slurry was adjusted to 6-7 with a pH adjusting agent (ammonia solution). No crack was found in the skim coat when the pH adjusted slurry was used. When attempts were made to prepare more samples for testing, it was found that sometimes, the cracks developed within a couple of hours during the drying process.

It is believed that cellulose derivatives with hydroxy functional groups can be used in plaster formulations to improve water retention, increase setting time and therefore prevent cracking. It can also allow hydration reaction occurring completely for fast hardness/strength development. Therefore, the new formulation was developed with the addition of hydroxyethyl cellulose (MW 90000).

### Use of Ammonia, Cellulose and Latex Powder

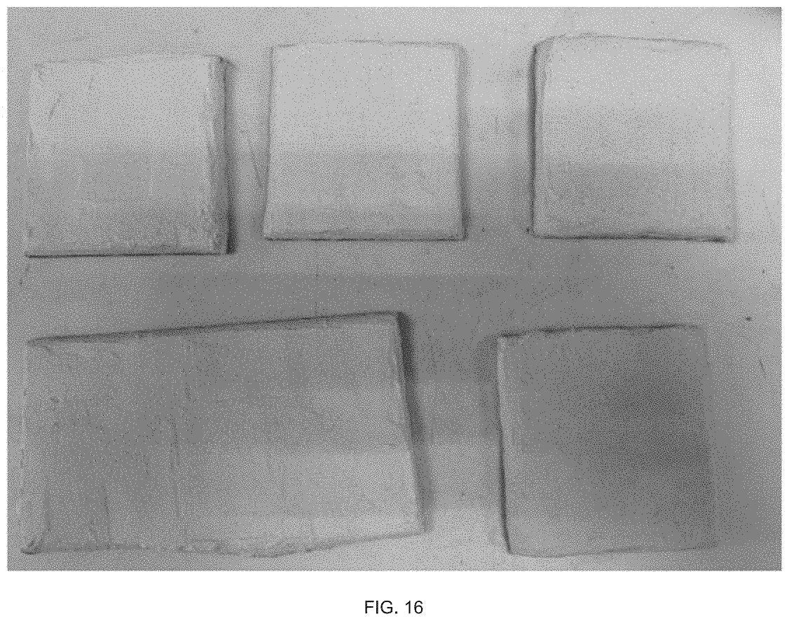

FIG. 16 shows images of skim coat samples prepared by adding ammonia, cellulose and latex powder. The skim coat samples were observed to harden quickly and remained crack-free.

### Example 5: Stages of Skim Coat Formulation Development

### Stage: Initial Input from an Earlier Investigation

Skim Coat Formulation:
Cement sand=40:60; add water to adjust to suitable viscosity

Remarks:
Suitable for blank sample preparation; low binding power with PCM; soft and powdery after curing

### Stage: Use of Dry PCM Capsule (Powder Form) in Formulation

Remarks:
Issue: cannot distribute well in the skim coat, low strength and stability after exposure
Solution 1: sieve to control particle size—still soft skim coat, low density
Solution 2: switch to slurry form PCM and use ball milling method to incorporate PCM capsule powder—slurry form PCM—mid density, sometimes cracked; Ball milling skim coat—high density, but thermal property affected, sometimes cracked

### Stage: Materials to Improve Strength, Stability and Consider

Skim Coat Formulation:
Materials checked: Metakaolin (improve strength); Diatomite (fine powder, porous structure); Calcium carbonate (fine powder)

Remarks:
Metakaolin tested at different ratios, no significant improvement observed
Diatomite/Calcium carbonate/sand—Diatomite can stabilize PCM oil when mixing together, also fine particle size can improve skim coat strength
Use a combination of diatomite and sand (1:2.4) to get both benefits

### Stage: Materials That Can Improve Fire Resistance

Skim Coat Formulation:
Expandable graphite

Remarks:
Mixing with skim coat, no adversary effect on properties (strength, adhesion) observed.

### Stage: Materials That Improve Substrate Adhesion and Provides Workability

Skim Coat Formulation:
Redispersible latex powder

Remarks:
Poor adhesion observed with PCM in the skim coat.
Tested at different concentrations: 0.5%; 1%; 2%
˜2% is good concentration that improves adhesion to substrates

### Stage: Materials That Neutralize Excessive Acid

Skim Coat Formulation:
Ammonia solution

Remarks:
pH of the slurry is not controlled well. A sample prepared earlier has a pH of 1
Low pH slurry affects the cement strength and results in cracks
Adjust slurry pH to 6-7 before mixing with cement

### Stage: Materials That Can Increase Water Retention Time and Minimize the Cracking

Skim Coat Formulation:
Hydroxyethyl cellulose (MW 90000)

Remarks:
Cracks were found to develop within a couple of hours after drying.
Cellulose can improve water retention in cement; increase drying time to allow hydration reaction occurred completely for fast hardness/strength development; reduce the cracks formulation during drying
0.25% to cement tested—hard skim coat without cracks obtained

### Example 6: Skim Coat Formulations

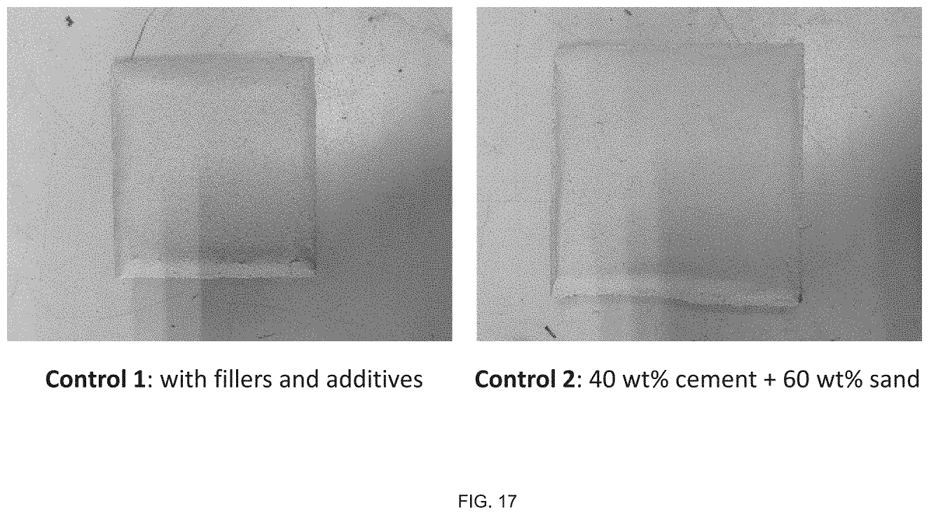

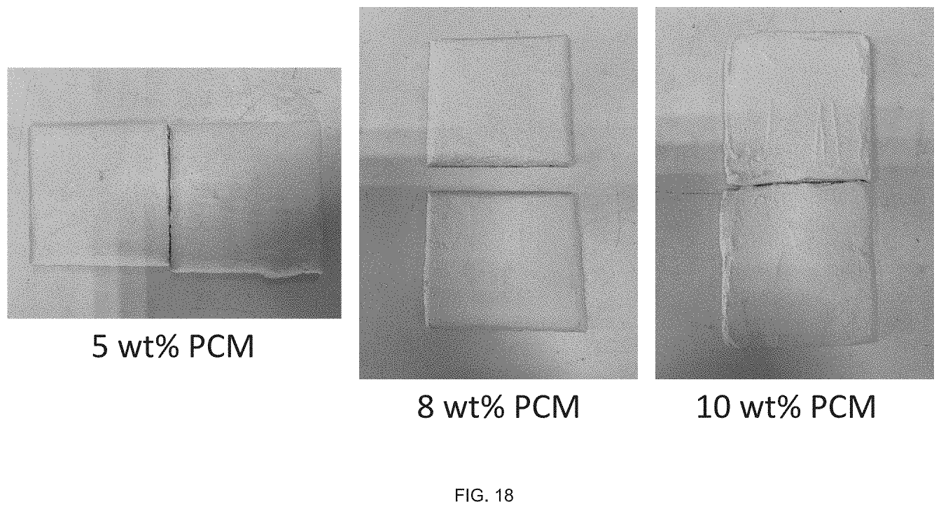

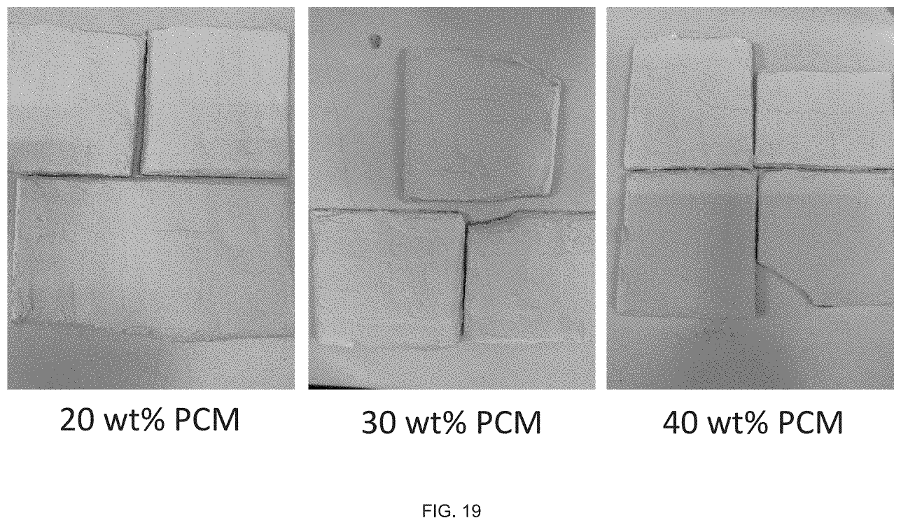

Skim coats in accordance with various embodiments disclosed herein were prepared with different concentrations of PCM (5 wt %-40 wt %). Two controls were used; control 1 contains fillers and additives while control 2 contains 40 wt % cement and 60 wt % sand (see FIG. 17). The concentration of PCM used was 5 wt %, 8 wt %, 10 wt %, 20 wt %, 30 wt % and 40 wt % respectively (see FIG. 18 and FIG. 19). The contents of the skim coat formulations are presented in Table 1 below.

TABLE 1
Skim coat with PCM capsules formulation
Skim Coat Formulations

| | | | | | | | Con- | Con- |
|---|---|---|---|---|---|---|---|---|
| | PCM capsule wt % | | | | | | trol | trol |
| | 40% | 30% | 20% | 10% | 8% | 5% | 1 | 2 |
| PCM | 105.9 | 79.5 | 53.0 | 27.7 | 21.4 | 15.0 | 0 | 0 |
| capsule | | | | | | | | |
| slurry (g) | | | | | | | | |
| Containing: | 40.0 | 30.0 | 20.0 | 10.0 | 8.0 | 5.0 | 0 | 0 |
| PCM (g) | | | | | | | | |
| Water in | 65.9 | 49.5 | 33.0 | 17.7 | 13.4 | 10.0 | 0 | 0 |
| PCM slurry | | | | | | | | |
| (g) | | | | | | | | |
| Cement (g) | 40.0 | 40.0 | 40.0 | 40.0 | 40.0 | 40.0 | 40 | 40 |
| Sand (g) | 10 | 20.0 | 26.8 | 34.3 | 35.0 | 38.0 | 41 | 60 |
| Diatomite | 7.6 | 8.0 | 11.1 | 13.7 | 15.0 | 15.0 | 17 | 0 |
| (g) | | | | | | | | |
| Latex | 2 | 2.0 | 2.0 | 2.1 | 2.0 | 2.0 | 2 | 0 |
| Powder (g) | | | | | | | | |
| Hydroxy- | 0.1 | 0.1 | 0.1 | 0.1 | 0.1 | 0.1 | 0.1 | 0 |
| ethyl | | | | | | | | |
| Cellulose | | | | | | | | |
| (g) | | | | | | | | |
| Water (g) | 13 | 16.5 | 26.4 | 34 | 40 | 40 | 34 | 34 |
| for | | | | | | | | |
| workability | | | | | | | | |
| Total water | 78.9 | 66 | 59.4 | 51.7 | 53.4 | 50 | 34 | 34 |
| (g) in paste | | | | | | | | |
| Coverage | 1.3 | 1.35 | — | — | 1.6 | 1.5 | 1.7 | 1.9 |
| (g paste/ | | | | | | | | |
| cm³) | | | | | | | | |

A unique skim coat formulation that is defect free and workable and meets the following requirements was successfully developed.

### Requirements of Skim Coat

Appearance
Tensile adhesion strength (14 days)
Compressive strength (28 days)
Accelerated weathering tests
To ensure compliance with the standard specifications required for building works in Singapore, a skim coat is required to display sufficient tensile adhesion strength (14 days), compressive strength (28 days) and withstand accelerated weathering testing.

### Additional Tests for Skim Coat with PCM

Temperature regulation effect
Thermal conductivity
Heat capacity

### Example 7: Performance of Skim Coats

In this example, the performance (in terms of thermal conductivity, specific heat capacity (by volume), thermal regulation effect, mini house tests, total solar reflectance etc.) of the skim coats prepared in accordance with various embodiments disclosed herein was investigated. The results are provided as follows.

### Thermal Conductivity

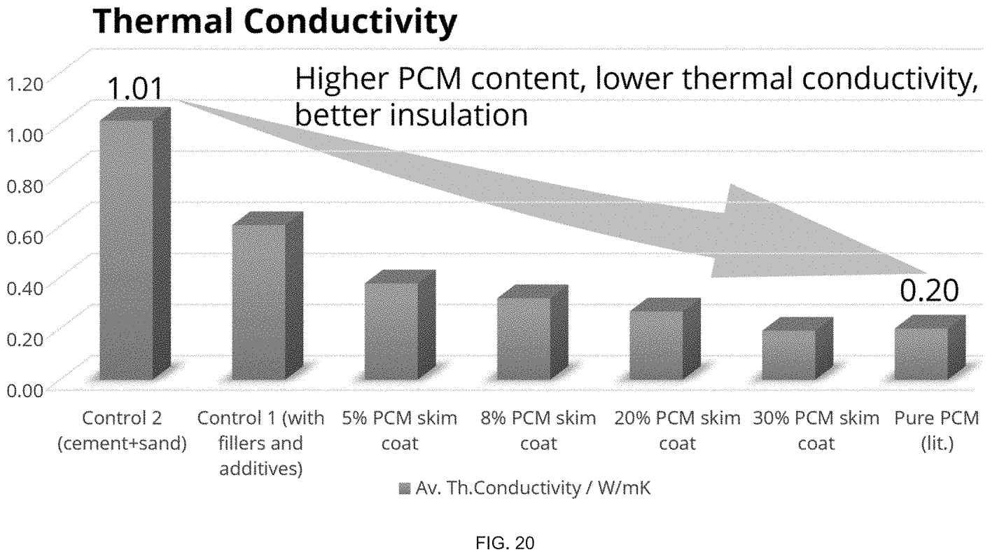

As shown in FIG. 20, the thermal conductivity of the skim coats decreases with increasing PCM content. A higher PCM content present in the skim coats imparts lower thermal conductivity and provides better insulation.

### Specific Heat Capacity (By Volume)

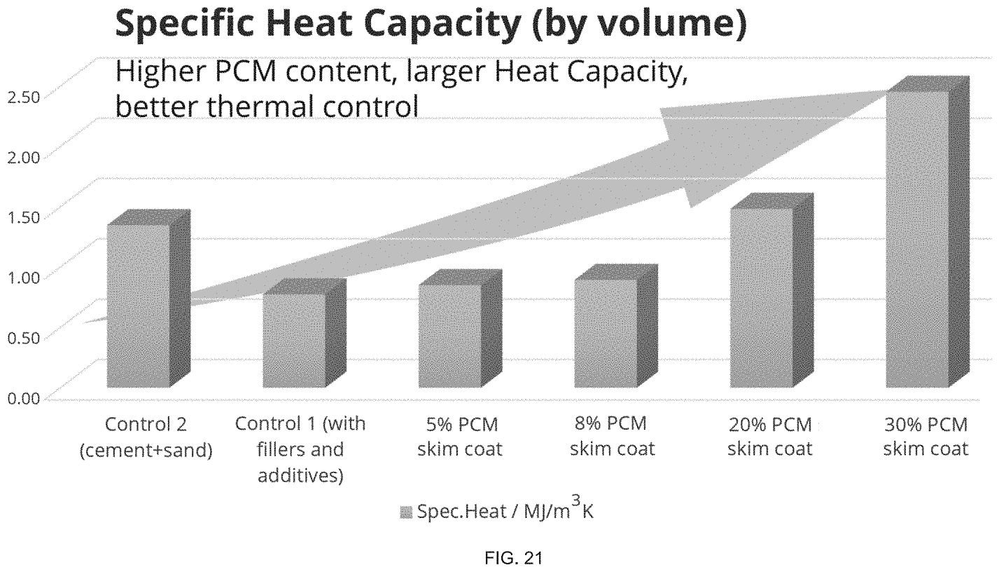

As shown in FIG. 21, the heat capacity of the skim coats increases with increasing PCM content. A higher PCM content present in the skim coats imparts larger heat capacity and provides better thermal control.

### Thermal Regulation Effect of PCM Skim Coats

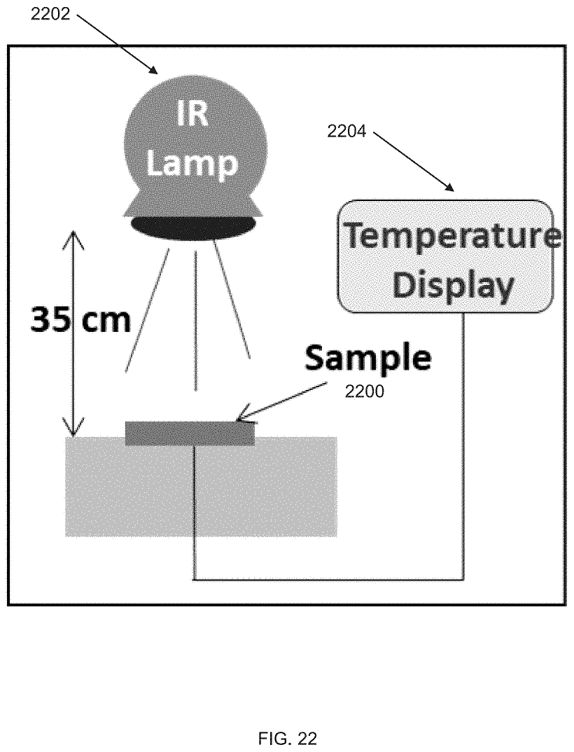

Thermal regulation effect of PCM skim coats was investigated by measuring back surface temperature in a laboratory set up as shown in FIG. 22.

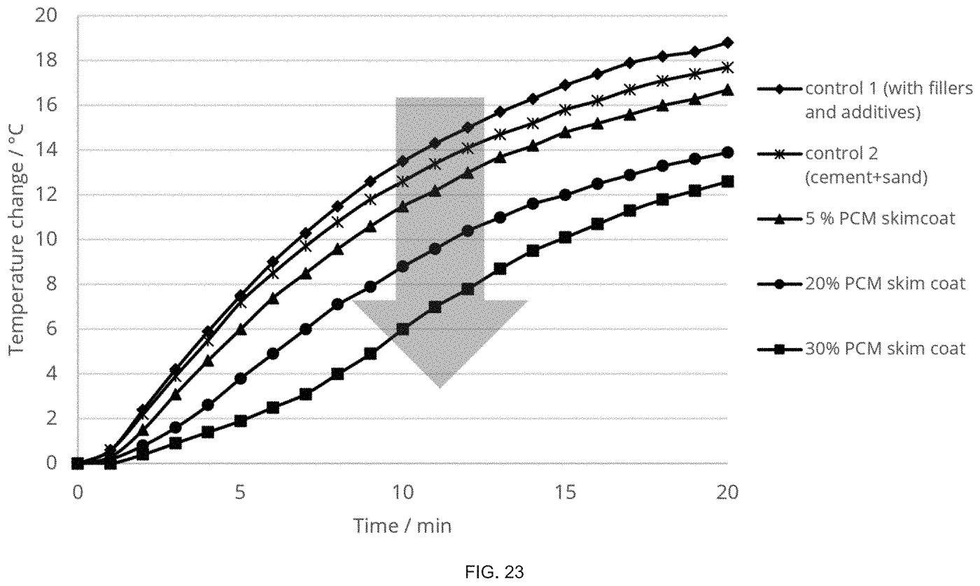

As shown in FIG. 23, the temperature change observed for 20% PCM skim coat (6 mm thickness) is ˜4° C.-5° C. lower and the temperature change observed for 30% PCM skim coat (6 mm thickness) is ˜6° C.-7° C. lower as compared to the controls. The thickness of the samples was measured at several points on the substrate and the measurements recorded were uniform at 6 mm.

The results show that PCM absorb the heat, imparts lower thermal conductivity and provides better insulation to the skim coats.

### Mini House Tests/Cool Roof House Thermal Tests

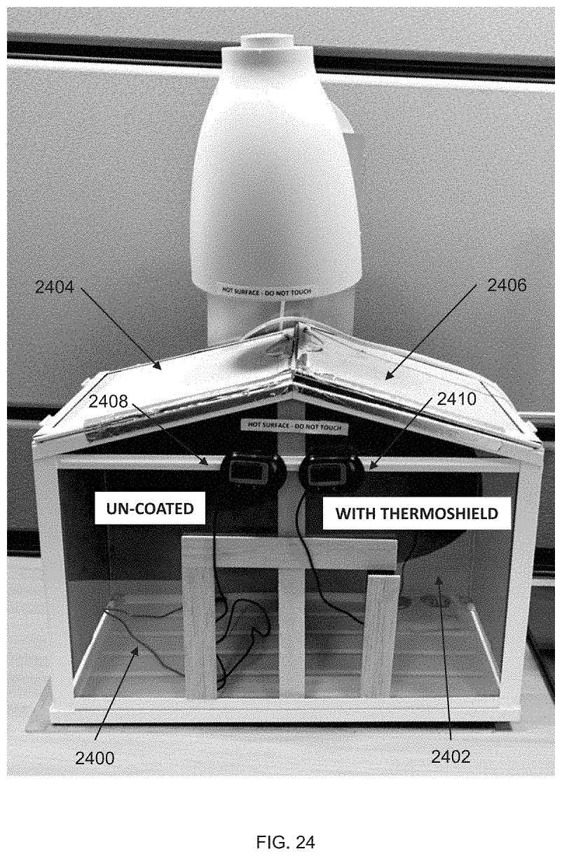

Mini house tests or cool roof house thermal tests were carried out to measure air temperature in a laboratory set up as shown in FIG. 24.

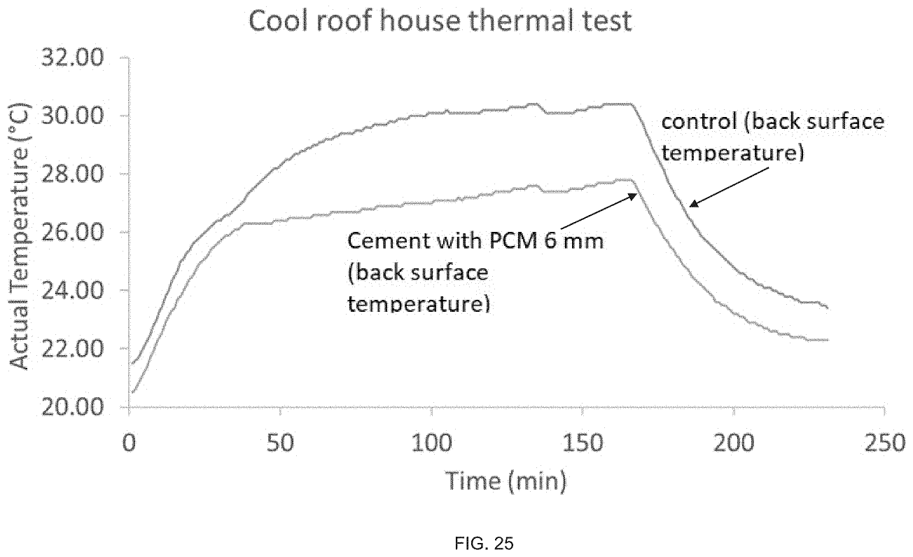

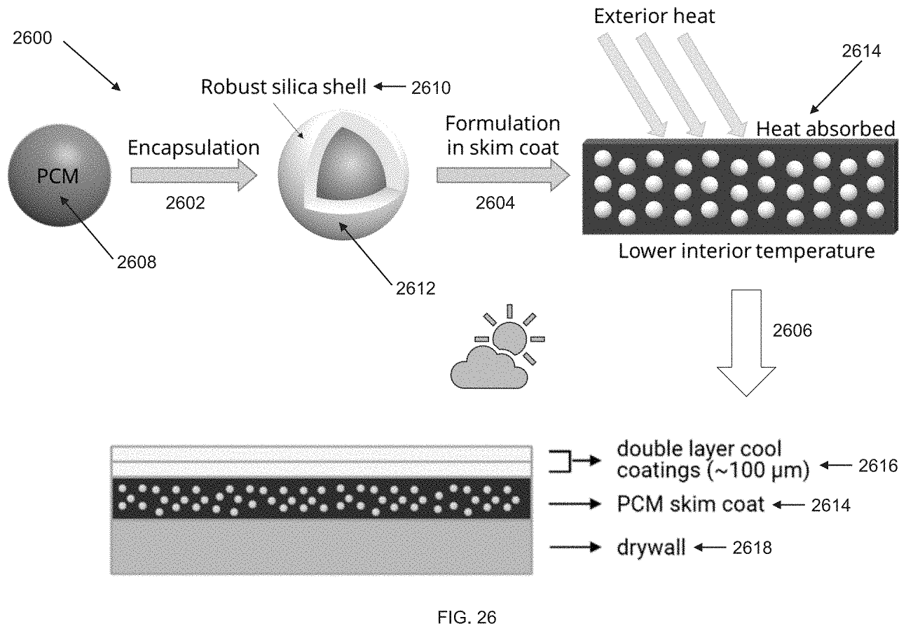

The results obtained are provided in FIG. 25. As compared to a control, the back surface temperature observed for PCM skim coat prepared from cement and 20 wt % PCM having a thickness of 6 mm is ˜4° C. lower over a time period of more than 2 hours. It is therefore shown that heat (for e.g., exterior heat) is absorbed by the PCM skim coat which leads to lower interior temperature and cooler interior air (see step 2604 of FIG. 26).

### Total Solar Reflectance of Skim Coat

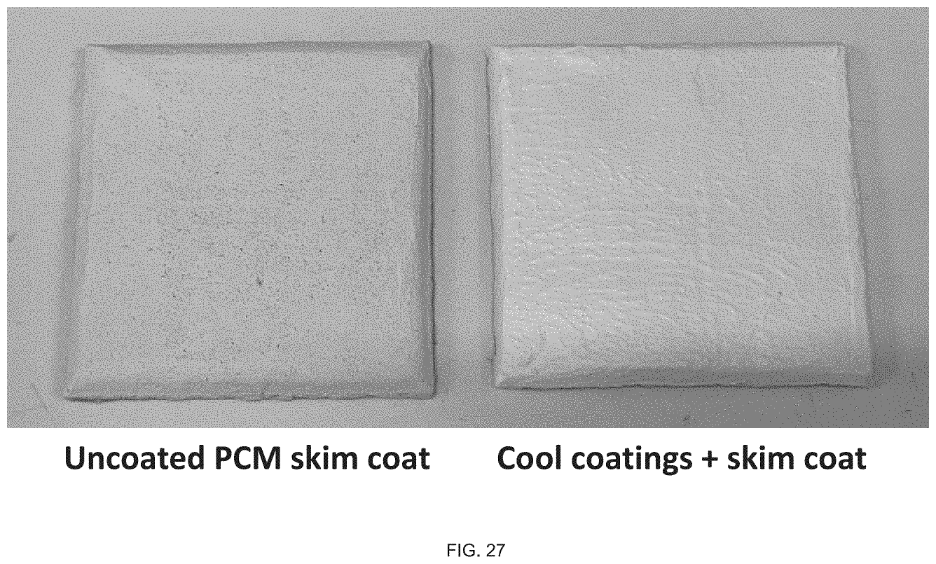

PCM skim coats were coated with cool coatings and their total solar reflectance were compared with PCM skim coats that were not coated with cool coatings (FIG. 26 and FIG. 27).

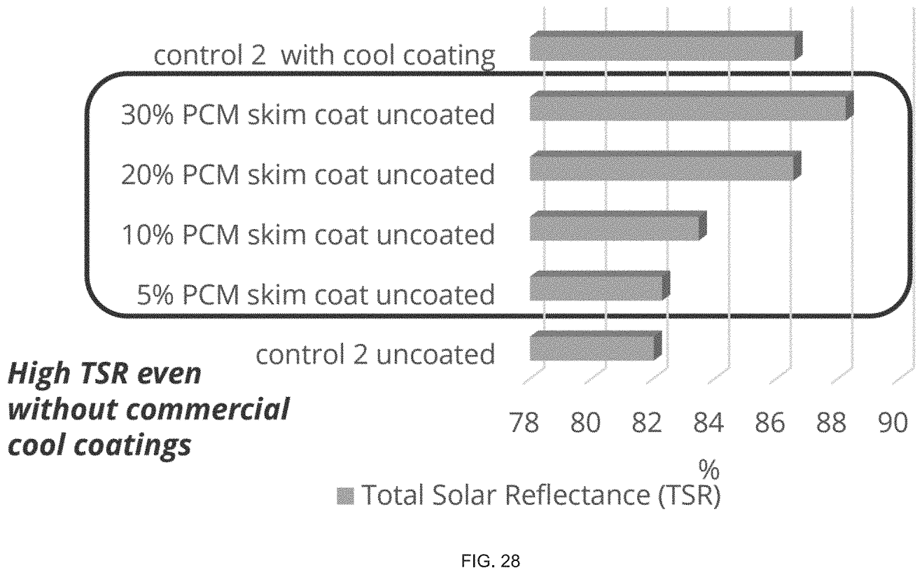

It was observed from FIG. 28 that the skim coat with PCM shows high TSR even without being coated with commercial cool coatings.

### Thermal Regulation Effect of PCM Skim Coat With/Without Cool Coatings

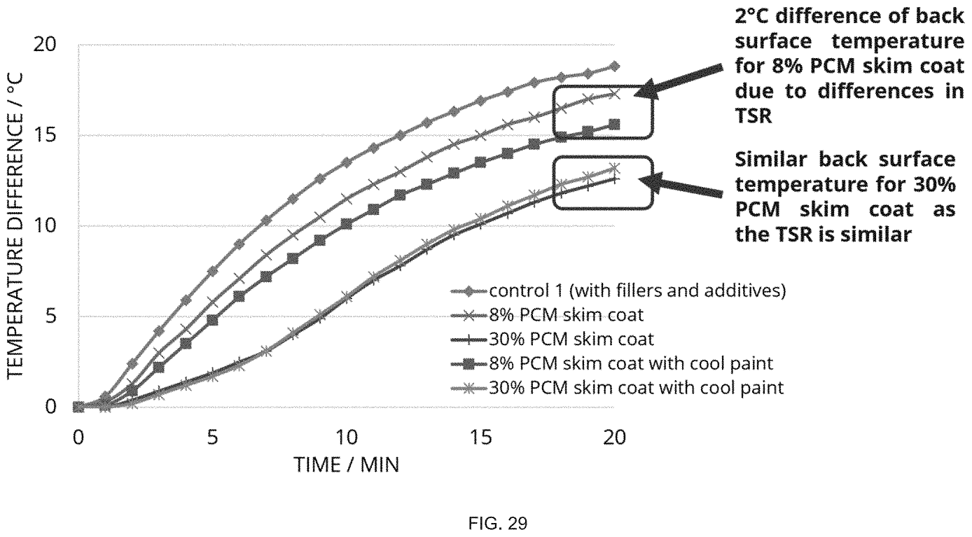

Experiments were conducted to compare the back surface temperature difference of PCM skim coats containing different PCM content (i.e. 8 wt % PCM and 30 wt % PCM) that are not coated with cool paint with those that are coated with cool paint (FIG. 29).

A 2° C. difference of back surface temperature was observed between PCM skim coat having 8 wt % PCM that is coated with cool paint and PCM skim coat having 8 wt % PCM that is not coated with cool paint due to differences in their TSR. Similar back surface temperature was observed for PCM skim coat having 30 wt % PCM that is coated with cool paint and PCM skim coat having 30 wt % PCM that is not coated with cool paint as their TSR are similar.
Advantageously, various embodiments of the method disclosed herein provides a highly compatible process for PCM encapsulation.
Embodiments of the method disclosed herein are scalable and allows silica based PCM capsules to be produced at a low cost with good cycling performance.
PCM skim coat formulations were developed with good thermal regulation effect.
Interestingly, the skim coat with PCM shows high TSR even without being coated by cool coatings.

### Example 8: Further Tests and Work

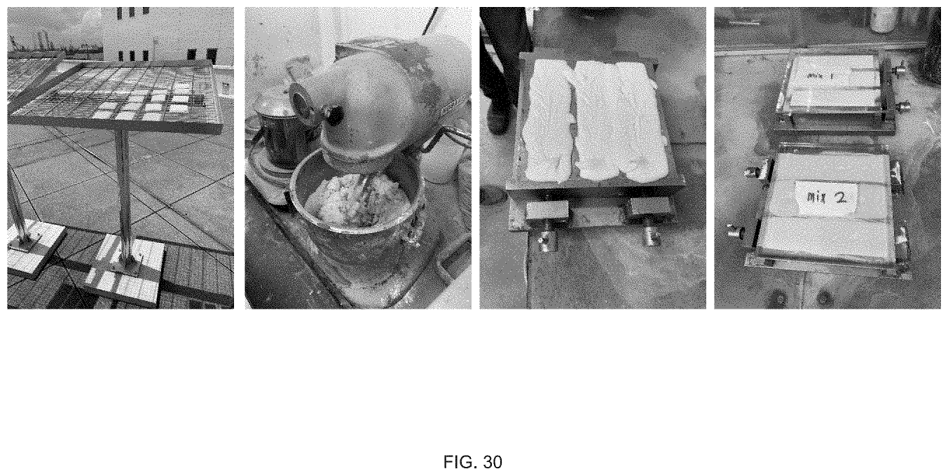

The skim coat formulations and skim coats prepared in accordance with various embodiments disclosed herein were subjected to the following tests:
Compressive strength and flexural strength
Outdoor exposure test to check the performance in actual conditions
Scale up PCM skim coat for additional tests (to comply with standard specifications required for building works in Singapore) and perform large scale field studies (FIG. 30)

### Example 9: Production of Robust Capsules Encapsulating CrodaTherm 29

Procedure for lab scale production of capsules encapsulating CrodaTherm 29 is described below.

The composition can be proportionately increased for scaling up to 50 kg. It will be appreciated that stirring speed will be different (slower) at larger reactors. Normally, stirring speed is adjusted to obtain the PCM droplet size in the range of 3-10 micrometers (monitored by sampling and checking under a microscope).
1. Triton X-100 (13.71 g) is added in a vial, followed by calcium chloride (0.33 g) and CrodaTherm 29 (76.41 g).
2. The above mixture is dissolved in ethanol/DI water in the ratio of 1:3 (150 ml:450 ml).
3. The mixture is stirred with overhead stirrer (slowly increased to 1000 rpm) and heated at 40° C. for at least 60 minutes.
4. 4.0 M HCl solution was used to adjust the pH to about 4.
5. The emulsion was stirred until droplet size reaches about 5-20 um (about 1.5 hrs).
6. TEOS (51.75 ml) was infused using syringe pump at 0.1 ml/min.
7. The reaction was left to stirred for 1 day (˜700 rpm) and monitored using microscope.
8. Upon completion of reaction, the suspension was filtered and washed with DI water and collected.
   CrodaTherm 29 (CM29) may also be replaced by other phase change materials such as OM29 (i.e. fatty acid mixtures), OM28p (i.e. paraffin mixtures) and SL28 (i.e. fatty acid ester mixtures).

### APPLICATIONS

Various embodiments of the present disclosure provide a strategy to formulate PCM slurry directly into a skim/plaster coat with appropriate additives.

Various embodiments of the composition and method disclosed herein allow for good adhesion to substrate with optimum temperature effects for e.g. a good balance between the temperature control and coating properties.

Various embodiments of the composition and method disclosed herein allow for commercially available additives to be added to give defect free surface of the coating.

Various embodiments of the composition and method disclosed herein allow for the provision of a coating that withstands weathering effects in Singapore.

Various embodiments of the composition and method disclosed allow for different PCM capsules with different phase transition temperature can be incorporated into the formulation.

Various embodiments of the composition and method disclosed herein may be used for other type of coatings other than skim coat for building energy efficiency and saving strategies. For example, the embodiments of the composition and method disclosed herein be applicable for recast cement panels or boards, precast light weight concrete panel (wet area and dry areas—hollow core and solid), food delivery insulation box, insulation board/foam/foam board, and/or refrigerator/food vending machine.

It will be appreciated by a person skilled in the art that other variations and/or modifications may be made to the embodiments disclosed herein without departing from the spirit or scope of the disclosure as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A composition comprising:
a slurry of capsules, the capsules having shells comprising silica and said shells encapsulating phase change materials (PCM); and
a cementitious binder.

2. The composition of claim 1, wherein the slurry has a pH of no less than 5.

3. The composition of claim 1, wherein the slurry comprises multivalent metal ions.

4. The composition of claim 3, wherein the multivalent metal ions comprise calcium ions.

5. The composition of claim 1, wherein the composition further comprises diatomite.

6. The composition of claim 1, wherein the composition further comprises one or more of latex, an organic polymer, filler, or graphite.

7. The composition of claim 5, wherein the composition comprises diatomite and filler at a ratio of from 1:3 to 1:1.

8. The composition of claim 6, wherein the latex when present is present at an amount of from 0.5 wt % to 10 wt % based on the dry weight of the composition, the filler when present is present at an amount of from 5 wt % to 55 wt % based on the dry weight of the composition, and the organic polymer when present is present at an amount of from 0.05 wt % to 0.5 wt %.

9. The composition of claim 1, wherein the capsules are present at an amount of from 2.5 wt % to 50 wt % based on the dry weight of the composition.

10. The composition of claim 1, wherein the cementitious binder is present at an amount of from 20 wt % to 60 wt % based on the dry weight of the composition.

11. The composition of claim 5, wherein the diatomite is present at an amount of from 5 wt % to 20 wt % based on the dry weight of the composition.

12. The composition of claim 1, wherein the total water content of the composition is from 5 wt % to 50 wt %.

13. The composition of claim 1 comprising:
from 10 wt % to 30 wt % of capsules based on the dry weight of the composition;
from 30 wt % to 50 wt % of cement based on the dry weight of the composition;
from 10 wt % to 50 wt % of sand and/or calcium carbonate based on the dry weight of the composition;
from 5 wt % to 20 wt % of diatomite based on the dry weight of the composition;
from 1 wt % to 5 wt % of latex based on the dry weight of the composition;
from 0.05 wt % to 0.5 wt % of cellulose based on the dry weight of the composition;
from 5 wt % to 50 wt % total water content of the composition; and
optionally from 0.1 wt % to 2 wt % of performance enhancing additives based on the dry weight of the composition.

14. A method of preparing the composition of claim 1, the method comprising:
providing a slurry of capsules, the capsules having shells comprising silica and said shells encapsulating phase change materials (PCM); and
mixing the slurry of capsules with a cementitious binder.

15. The method of preparing the composition of claim 14, wherein providing the slurry of capsules comprises:
adding a silica precursor to emulsified droplets of PCM in the presence of salt and alcohol to enhance silica growth around the emulsified droplets, thereby forming the slurry of capsules having shells comprising silica and encapsulating PCM.

16. The method of preparing the composition of claim 15, wherein the salt comprises a multivalent metal salt, the silica precursor comprises an alkoxy silane and the alcohol is selected from the group consisting of: methanol, ethanol, propanol, isopropanol and combinations thereof.

17. The method of preparing the composition of claim 15, further comprising adding a pH adjusting agent to the slurry of capsules to obtain a pH of no less than 5.

18. The method of preparing the composition of claim 17, wherein the pH adjusting agent comprises an alkaline pH adjusting agent.

19. The method of preparing the composition of claim 15, further comprising mixing one or more of a filler, diatomite, latex and organic polymer with the slurry of capsules.

20. The method of preparing the composition of claim 15, wherein the method comprises:
adding cement, sand and/or calcium carbonate, diatomite, latex and cellulose to the slurry of capsules; and
optionally adding additional water to the mixture of cement, sand and/or calcium carbonate, diatomite, latex, cellulose and capsules,
wherein the final composition comprises from 10 wt % to 30 wt % of capsules based on the dry weight of the composition, from 30 wt % to 50 wt % of cement based on the dry weight of the composition, from 10 wt % to 50 wt % of sand and/or calcium carbonate based on the dry weight of the composition, from 5 wt % to 20 wt % of diatomite based on the dry weight of the composition, from 1 wt % to 5 wt % of latex based on the dry weight of the composition, from 0.05 wt % to 0.5 wt % of cellulose based on the dry weight of the composition, and from 5 wt % to 50 wt % total water content of the composition.
